(19) United States
(12) Patent Application Publication
(10) Pub. No.: US 2019/0115587 A1
(43) Pub. Date: Apr. 18, 2019

(54) Core-Shell Cathodes for Lithium-Sulfur Batteries

(71) Applicant: Board of Regents, The University of Texas System, Austin, TX (US)

(72) Inventors: Arumugam Manthiram, Austin, TX (US); Sheng-Heng Chung, Austin, TX (US)

(21) Appl. No.: 16/217,495

(22) Filed: Dec. 12, 2018

Related U.S. Application Data
(63) Continuation of application No. PCT/US2017/034170, filed on May 24, 2017.
(60) Provisional application No. 62/349,465, filed on Jun. 13, 2016.

(51) Int. Cl. H01M 4/136; H01M 10/0525; H01M 10/058; H01M 4/38; H01M 4/62; H01M 4/36

(52) U.S. Cl. CPC H01M 4/136; H01M 10/0525; H01M 4/366; H01M 4/382; H01M 4/625; H01M 10/058

(57) ABSTRACT

The present disclosure relates to a cathode for a Lithium-Sulfur (Li—S) battery including an electrically conductive, porous shell and a sulfur-based core enclosed within the shell. The electrically conductive, porous substantially encloses the sulfur-based core on a macro-scale and substantially blocks passage of polysulfides from the cathode. The present disclosure further includes Li—S batteries containing such cathodes and methods of assembling such cathodes and batteries.

### PRIORITY CLAIM

The present application is a continuation of International Application No. PCT/US2017/034170 Filed May 24, 2017; which claims priority to U.S. Provisional Patent Application Ser. No. 62/349,465, filed Jun. 13, 2016, the contents of which are incorporated by reference herein in their entirety.

### STATEMENT OF GOVERNMENT INTEREST

This invention was made with United States Government support under Grant no. DE-EE0007218 awarded by the Department of Energy. The United States Government has certain rights in the invention.

### TECHNICAL FIELD

The present disclosure relates to a cathode with a core-shell structure (a “core-shell cathode”) for lithium-sulfur (Li—S) batteries, batteries containing a core-shell cathode, and method of making a core-shell cathode.

### BACKGROUND

### Basic Principles of Batteries and Electrochemical Cells

Batteries may be divided 30 into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode (cathode) and the negative electrode (anode), an insulator separating the electrodes so the battery does not short out, and an electrolyte that chemically connects the electrodes.

In operation, the secondary battery exchanges chemical energy and electrical energy. During discharge of the battery, electrons (e⁻), which have a negative charge (−), leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge (+) leaves the anode and enters the electrolyte and then a positive ion leaves the electrolyte and enters the cathode. In order for this ion movement to work, typically the same type of ion leaves the anode and joins the cathode. Additionally, the electrolyte typically also contains this same type of ion.

In order to recharge the battery, the same process happens in reverse. By supplying energy to the cell, electrons are induced to leave the cathode and join the anode. At the same time, a positive ion, such as a lithium ion (Li⁺), leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries, it forms a coating on the metal backing. The metal backing is electrically conductive and electrically connects the active material to other parts of the battery and, ultimately, the exterior of the battery. Because the metal backing accumulates electrical current from the active material, it is also often referred to as a “current collector.”

Several important properties of rechargeable batteries include energy density, power density, rate capability, cycle life, cost, and safety. Current lithium ion battery technology based on insertion compound cathodes and anodes is limited in energy density. This technology also suffers from safety concerns arising from the chemical instability of oxide cathodes under conditions of overcharge and also frequently requires the use of expensive transition metals. Accordingly, there is immense interest in developing alternative cathode materials for lithium ion batteries. Sulfur has been considered as one such alternative cathode material.

### Lithium-Sulfur Batteries

Lithium-sulfur (Li—S) batteries are a particular type of rechargeable battery that contain sulfur (S) as the cathode active material. S is an attractive cathode active material candidate as compared to traditional lithium ion battery cathode active materials because it offers a high theoretical specific capacity (1672 mAh/g). This high theoretical capacity is due to the ability of S to accept two electrons (e) per atom. Li—S batteries also have a high theoretical specific energy of 2600 Wh/kg. In addition, most Li—S batteries operate at a safe voltage range (1.5-3.0 V). Furthermore, sulfur is inexpensive and environmentally benign, as compared to many other cathode materials usable in lithium ion batteries.

In addition, unlike current lithium ion batteries in which the Li⁺ actually moves into and out of the crystal lattice of an insertion compound, the Li⁺ in Li—S batteries reacts with sulfur in the cathode to produce a discharge product with different crystal structure. The Li⁺ does not need to move into and out of either the sulfur or the discharge product. Rather, during discharge, particles of elemental sulfur (S) react with the Li⁺ to form Li₂S in the cathode. When the battery is recharged, Li⁺ leave the cathode, allowing to revert to S.

In most Li—S batteries, the anode is lithium metal (Li or Li⁰). In operation, lithium leaves the metal as Li⁺ and enters the electrolyte when the battery is discharging. When the battery is recharged, Li⁺ leave the cathode and plate out on the lithium metal anode as Li. Although lithium metal anodes are often preferred because they confer the highest possible operating voltage and also do not require Li⁺ to move into and out of a crystal lattice, other Li⁺ anodes, including those based on insertion compounds, may also be used in a Li—S battery. Typically, these anodes operate by releasing Li⁺ into the electrolyte when the battery is discharging and by removing Li⁺ from the electrolyte when the battery is recharged.

Despite the potential advantages of Li—S batteries, their practical applicability is currently limited by their poor ability to perform at neat theoretical levels, their poor cycle stability, poor capacity retention, low Coulombic efficiency, and severe self-discharge effect.

These disadvantages arise of the insulating nature of sulfur and its reduction compounds with lithium (Li₂S₂/Li₂S mixtures). This insulating nature decreases the actual specific capacity to an unacceptably low fraction of the theoretical value because only a small fraction of the active material in the cathode is electrochemically accessible, unless the electrochemical reactions between lithium ions and sulfur particles occur in electrolytes near a conductive matrix or in the porous spaces of a conductive host. However, such close contact among the active material, electrolyte, and conductive host is hard to maintain in the harsh chemical and electrochemical environment of Li—S cells. S has a volume of 2.07 g/cm³, while Li₂S has a volume of 1.66 g/cm³. The repeated solid_{(sulfur)}-liquid_{(polysulfides)}-solid_{(sulfides)} phase transformations and the huge (80%) volume change between sulfur and sulfides during cycling damage the integrity and stability of electrodes during extended cycles, resulting in increasing lack of adequate electrical contact between the S and the current collector and eventual failure of the battery.

Furthermore, during discharge, the S cathode active material does not react with Li⁺ to immediately form Li₂S. Rather, polysulfides are formed as an intermediate reaction product. These polysulfides dissolve easily in the electrolyte and, as a result often reach the Li-metal anode, where they undergo chemical reduction and form insoluble Li₂S₂/Li₂S mixtures. As these end-reduction products are insulating and poorly soluble, the Li₂S₂/Li₂S mixtures precipitate and induce a passivation of the electrodes. The time-dependent electrode degradation causes a fast capacity fade and a short cycle life.

In one particularly problematic effect of electrolyte solubility, high-order polysulfides (Li₂Sₙ, 4≤n≤8) move toward the lithium metal anode, where they are reduced to lower-order polysulfides. These lower order polysulfides (Li₂Sₙ, 1≤n≤2) are markedly less soluble than high-order polysulfides or are insoluble in the electrolyte. As a result, they remain near the anode and may even nucleate to form larger, insoluble particles.

There has been intense focus on controlling polysulfide dissolution and diffusion in Li—S batteries. The approaches range from encapsulating the sulfur at a micro or nano-scale in porous carbon structures by taking advantage of the strong affinity of sulfur for carbon-based materials to reducing the active-material loss to the electrolyte by utilizing the strong chemical interactions of polysulfide species with electrolyte additives. These materials science and engineering approaches have generally been employed to form Li—S battery cathodes with a low sulfur loading of <2 mg/cm⁻², resulting in low energy density. In order for Li—S batteries to be commercially viable, a higher sulfur loading is needed, but few designed have even attempted it.

### SUMMARY

The present disclosure relates to a core-shell cathode for a Li—S battery in which a sulfur-based core is enclosed within an electrically conductive, porous shell, such as a carbon-based shell. The core-shell structure is present on a macro, not a micro or nano scale, with the shell being formed from a porous material, such as carbon paper layers and the sulfur-based core being defined by a volume with the shell, such as a volume defined by the thin, porous layers.

A battery containing a core-shell cathode may further include an anode and an electrolyte. The battery may further contain a catholyte located or formed within the sulfur-based core.

The disclosure further provides method of assembling a core-shell cathode including forming a portion of the shell, placing the sulfur-based core within the shell, then completing the shell.

More specifically, the disclosure provides a core-shell cathode including an electrically conductive, porous shell and a sulfur-based core enclosed within the shell. The electrically conductive, porous substantially encloses the sulfur-based core on a macro-scale and substantially blocks passage of polysulfides from the cathode.

The disclosure also provides a Li—S battery including such a cathode, along with an electrolyte.

The disclosure further provides the following more detailed features of the core-shell cathode or a Li—S battery containing a core-shell cathode, which features may be combined with one another in any combinations unless clearly mutually exclusive; i) the electrically conductive, porous shell may include a first layer, an O-ring located on the first layer to form a volume that contains the sulfur-based core, and a second layer located on the O-ring to enclose the sulfur-based core; ii) the electrically conductive, porous shell may include an electrically conductive, porous carbon material; ii-a) the porous carbon material may include carbon nanofibers and carbon nanotubes, including single-walled carbon nanotubes, double-walled carbon nanotubes, multi-walled carbon nanotubes, or any combination thereof; ii-b) the porous carbon material comprises carbon particles, graphene, or any combination thereof; iii) the electrically conductive, porous shell may include a conductive polymer; iv) the electrically conductive, porous shell may include a metal foam; iv) the sulfur-based core may include elemental sulfur in the form of particles; v) the sulfur-based core may include a lithium sulfide or polysulfide having the general formula Li₂Sₙ, 1≤n≤8; vi) the sulfur-based core may include a catholyte; vii) the cathode may be substantially planar and have a sulfur loading of at least 4 mg/cm²; viii) the cathode may have a sulfur loading of at least 40 wt %, based on total weight of the core and shell; ix) the cathode may have a sulfur loading of at least 4 mg/cathode; x) the cathode may have a sulfur loading of at least 3 g/cm³; xi) the cathode may have an areal capacity of at least 5 mAh/cm²; xii) the cathode may have a volumetric capacity of at least 500 mAh/cm³; xiii) the cathode may have an electrode capacity of at least 600 mAh/g; xiv) the cathode may have has a specific capacity of at least 1600 mAh/g; xv) the cathode, when used in a battery may have a sulfur utilization of at least 90%, when cycled at any C-rate between C/20 and C/2; xv) the cathode, when used in a battery may have a peak discharge capacity of at least 700 mAh/g at C/5 rate; xvi) a battery containing the core-shell cathode may have a capacity retention of at least 75% over a three-month rest period; xvii) a battery containing the core-shell cathode may have a capacity fade of less than 0.1%, per day over a three-month rest period.

### BRIEF DESCRIPTION OF THE DRAWINGS

A more complete understanding of the present embodiments and advantages thereof may be acquired by referring to the following description taken in conjunction with the accompanying drawings, which relate to embodiments of the present disclosure. The current specification contains color drawings. Copies of these drawings may be obtained from the USPTO.

FIG. 1 is a schematic diagram of a core-shell cathode.

FIG. 2A, FIG. 2B, and FIG. 2C are schematic diagrams and corresponding photographs of steps during assembly of the core-shell cathode of FIG. 1.

FIG. 3 is a schematic diagram of a jelly-roll Li—S batter with a core-shell cathode.

FIGS. 4a-4d present the results of analysis of a carbon paper suitable for use in the shell prior to cathode formation or cycling. FIG. 4a and FIG. 4b are low and high magnification scanning electron microscope (SEM)/energy dispersive X-ray (EDX) inspections. FIG. 4c is a Raman spectrum. FIG. 4d is a graph of the discharge capacity versus cycle number.

FIGS. 5a-5d present microstructural and SEM/EDX analysis of a carbon paper shell of a core-shell cathode that has been formed, but not cycled. FIG. 5a and FIG. 5b are low and high magnification SEM/EDX inspections for the carbon paper from the center of the cathode. FIG. 5c and FIG. 5d are low and high magnification SEM/EDX inspections for the carbon paper from the edge of the cathode.

FIGS. 6a-6d present microstructural and SEM/EDX analysis of a carbon paper shell of a core-shell cathode that was cycled for 100 cycles then charged at 3.0 V. FIG. 6a and FIG. 6b are low and high magnification SEM/EDX inspections for the carbon paper from the edge of the cathode. FIG. 6c and FIG. 6d are low and high magnification SEM/EDX inspections for the carbon paper from the center of the cathode.

FIGS. 7a-7h present microstructural and SEM/EDX analysis of the carbon paper shell of core-shell cathodes with different sulfur loadings after the cathodes were cycled for 100 cycles then charged at 3.0 V. FIG. 7a-FIG. 7f present analyses of the outer surface of the carbon paper shell. FIG. 7g and FIG. 7h present analyses of the inner surface of the carbon paper shell, adjacent the sulfur-based core. Sulfur loading in FIG. 7a and FIG. 7g was 4 mg/cm². Sulfur loading on FIG. 7b was 6 mg/cm². Sulfur loading on FIG. 7c was 8 mg/cm². Sulfur loading on FIG. 7d was 10 mg/cm². Sulfur loading on FIG. 7e was 20 mg/cm². Sulfur loading in FIG. 7f and FIG. 7h was 30 mg/cm².

FIGS. 8a-8b present microstructural and SEM/EDX analysis of a sulfur-based core of a core-shell cathode. FIG. 8a presents results for sulfur powder prior to formation of a core-shell cathode. FIG. 8b presents results after formation of the core-shell cathode, but before cycling.

FIGS. 9a-9c present microstructural and SEM/EDX analysis of a sulfur-based core of a core shell cathode that was cycled for 100 cycles then charged at 3.0 V. FIGS. 9a, 9b and 9c present results at increasing magnification.

FIGS. 10a-10b present dynamic electrochemical test results for Li—S batteries with core-shell cathodes having sulfur loadings between 4 mg/cm² and 30 mg/cm². FIG. 10a presents discharge and charge profiles, while FIG. 10b presents QH and QL analyses.

FIG. 11a presents discharge and charge profiles of Li—S batteries with core-shell cathodes having sulfur loadings of 4 mg/cm², 6 mg/cm² (FIG. 11b), 8 mg/cm² (FIG. 11c), 10 mg/cm² (FIG. 11d), 20 mg/cm² (FIG. 11e), and 30 mg/cm² (FIG. 11f).

FIG. 12 presents charge and discharge profiles of a Li—S battery with a conventional cathode having a sulfur loading of 4 mg/cm².

FIGS. 13a-13b present electrochemical impedance spectroscopy (EIS) analysis of the Li—S batteries with core-shell cathodes having sulfur loadings sulfur loadings between 4 mg/cm² and 30 mg/cm² and a Li—S battery with a conventional cathode having a sulfur loading of 4 mg/cm². FIG. 13a presents results before battery cycling, while FIG. 13b presents results after cycling for 100 cycles.

FIG. 14a presents cyclic voltammograms of Li—S batteries with core-shell cathodes having sulfur loadings of 4 mg/cm², 6 mg/cm² (FIG. 14b), 8 mg/cm² (FIG. 14c), 10 mg/cm² (FIG. 14d), 20 mg/cm² (FIG. 14e), and 30 mg/cm² (FIG. 14f).

FIGS. 15a-15d present results of cycling Li—S batteries with core-shell cathodes with various sulfur loadings from 4 to 30 mg/cm² at various cycling rates: FIG. 15a at C/20, FIG. 15b at C/10, FIG. 15c at C/5, and FIG. 15d at C/2 rates.

FIG. 16 presents a comparison of the rate capabilities of Li—S batteries with core-shell cathodes with various sulfur loadings from 4 to 30 mg/cm² at cycling rates between C/20 and C/2.

FIGS. 17a-17c present battery performance data for Li—S batteries with core-shell cathodes with various sulfur loadings from 4 to 30 mg/cm² at a C/10 rates. FIG. 17a presents (a) areal capacity (mAh/cm²). FIG. 17b presents gravimetric capacity (mAh/g). FIG. 17c presents volumetric capacity (mAh/cm³) of the whole electrode.

FIGS. 18a-18e present battery performance data and microstructural and SEM/EDX analysis for Li—S batteries with core-shell cathodes with various sulfur loadings from 4 to 30 mg/cm² after resting for three months. FIG. 18a presents open circuit voltage (OCV) data. FIG. 18b presents self-discharge behavior. FIG. 18c presents microstructural and SEM/EDX analysis of a core-shell cathode. FIG. 18d presents EDX analysis specifically of the sulfur-based core of a 4 to 30 mg/cm² core-shell cathode. FIG. 18e presents EDX analysis of the carbon paper shell.

FIG. 19 presents a graph of the natural logarithm of upper-plateau discharge capacity (QH) divided by the original upper-plateau discharge capacity (QH₀) as a function of resting time (TR) for self-discharge constant calculation (the inset is the self-discharge constant fitting).

FIG. 20a presents time-dependent EIS analysis of the Li—S batteries with core-shell cathodes having sulfur loadings sulfur loadings of 4 mg/cm², 6 mg/cm² (FIG. 20b), 8 mg/cm² (FIG. 20c), 10 mg/cm² (FIG. 20d), 20 mg/cm² (FIG. 20e), and 30 mg/cm² (FIG. 20f), of any combination graph (FIG. 20g).

FIG. 21a presents microstructural and SEM/EDX analysis for Li—S batteries with core-shell cathodes having sulfur loadings of 4 mg/cm², 6 mg/cm² (FIG. 21b), 8 mg/cm² (FIG. 21c), 10 mg/cm² (FIG. 21d), 20 mg/cm² (FIG. 21e), and 30 mg/cm² (FIG. 21f), after resting for a three-month rest period.

FIG. 22a presents microstructural and SEM/EDX analysis for Li—S batteries with core-shell cathodes having sulfur loadings of 4 mg/cm² after one month of rest, two months of rest (FIG. 22b), or three months of rest (FIG. 22c).

FIG. 23a presents microstructural and SEM/EDX analysis for Li—S batteries conventional cathodes having sulfur loadings of 4 mg/cm² after one month of rest, FIG. 23b presents two months of rest, or FIG. 23c presents three months of rest.

FIG. 24a is a schematic diagram of a polysulfide-trap Li—S battery. FIG. 24b presents microstructural and SEM/EDX data of the polysulfide trap. FIG. 24c presents microstructural and scanning transmission electron microscope (STEM)/EDX data of the polysulfide trap.

FIG. 25a presents STEM/EDX data for the polysulfide trap after 100 cycles of a Li—S battery containing a core-shell cathode having a sulfur loading of 4 mg/cm², or a conventional cathode having a sulfur loading of 4 mg/cm² (FIG. 25b).

FIG. 26a presents SEM/EDX data for the polysulfide trap after 100 cycles from Li—S batteries with core-shell cathodes having sulfur loadings of 4 mg/cm², 6 mg/cm² (FIG. 26c), 8 mg/cm² (FIG. 26d), 10 mg/cm² (FIG. 26e), 20 mg/cm² (FIG. 26f), and 30 mg/cm² (FIG. 26g), or a conventional cathode having a sulfur loading of 4 mg/cm² (FIG. 26b).

FIG. 27a presents STEM/EDX data for the polysulfide trap after 100 cycles from Li—S batteries with core-shell cathodes having sulfur loadings of 4 mg/cm², 6 mg/cm² (FIG. 27c), 8 mg/cm² (FIG. 27d), 10 mg/cm² (FIG. 27e), 20 mg/cm² (FIG. 27f), or a conventional cathode having a sulfur loading of 4 mg/cm² (FIG. 27b).

FIG. 28a presents STEM/EDX data for the polysulfide trap of a Li—S battery containing a core-shell cathode having a sulfur loading of 4 mg/cm², or a conventional cathode having a sulfur loading of 4 mg/cm² (FIG. 28b), after three months of rest.

FIG. 29a presents SEM/EDX data for the polysulfide trap from Li—S batteries with core-shell cathodes having sulfur loadings of 4 mg/cm², 6 mg/cm² (FIG. 29c), 8 mg/cm² (FIG. 29d), 10 mg/cm² (FIG. 29e), 20 mg/cm² (FIG. 29f), and 30 mg/cm² (FIG. 29g), or a conventional cathode having a sulfur loading of 4 mg/cm² (FIG. 29b), after three months of rest.

FIG. 30a presents STEM/EDX data for the polysulfide trap from Li—S batteries with core-shell cathodes having sulfur loadings of 4 mg/cm², 6 mg/cm² (FIG. 30c), 8 mg/cm² (FIG. 30d), 10 mg/cm² (FIG. 30e), 20 mg/cm² (FIG. 30f), or a conventional cathode having a sulfur loading of 4 mg/cm² (FIG. 30b), after three months of rest.

### DETAILED DESCRIPTION

The present disclosure relates to a core-shell cathode for a Li—S battery in which a sulfur-based core is enclosed within an electrically conductive, porous shell. The disclosure further provides method of making such a core-shell cathode and a Li—S battery containing such a core-shell cathode.

Although prior cathodes containing both electrically conductive, porous materials and sulfur have been developed, these sulfur-based composite cathodes have focused on micrometer or nanometer scale features of the porous materials for containing the sulfur. Such a structure is often designed to work with a traditional lithium ion battery cathode configuration in which the composited cathode active material and a binder are deposited on current collector. PVDF binder and aluminum foils have been reported to be, respectively, prone to electrode deterioration and metal corrosion in the Li—S batteries. The present disclosure is based, at least in part, on the realization that a traditional lithium ion battery cathode configuration is not ideal for a Li—S battery.

The core-shell cathode of the present disclosure, while compatible with some sulfur-based cores in which sulfur is contained within a micro or nano-scale porous material, does not require such a configuration. Instead, the core-shell cathode may also function with pure sulfur or a sulfur-based core composite in which the sulfur is not entirely enclosed within a micro or nano-scale porous material. This ability arises from the novel macro-scale cathode design, in which a porous shell surrounds a sulfur-based core that is defined by a volume within the shell. This core-shell cathode encloses the sulfur-based core at a macro-scale. It may function without any binders or current collectors, such that the amount of inactive material in the cathode is significantly decreased as compared to traditional cathodes and cathode assembly is simplified. This macro-scale cathode design may also impart any of a number of useful properties and improvements as compared to other Li—S cathodes and batteries containing them.

The shell may differ in shape and dimension to allow different shaped core-shell cathodes to be formed for different Li—S battery configurations. For instance a plurality of thin, porous material layers may be used to define the volume in which the sulfur-based core is contained. The porous shell may also be formed as one piece or two pieces, making a container for the sulfur-based core and a lid. The principle feature of the core-shell cathode is that it contains a porous shell that allows electrolyte to pass through and contact the sulfur-based core, which is enclosed in the shell. Although the porous shell may enclose some sulfur or sulfur compounds on the micro or nano-scale, particularly when the sulfur or sulfur compounds tend to migrate from the cathode, the majority of the sulfur and sulfur compounds in the sulfur-based core are enclosed by the shell only on a macro-scale. The volume for enclosing the sulfur-based core defined by the shell may control or be a significant factor in the sulfur loading of the core-shell cathode.

In general, a shell, core, core-shell cathode, and Li—S battery may have any properties described herein alone or in combination unless they are clearly mutually exclusive. Methods of forming the shell, core, core-shell cathode, and Li—S battery may include combinations of any methods described herein, unless clearly mutually exclusive.

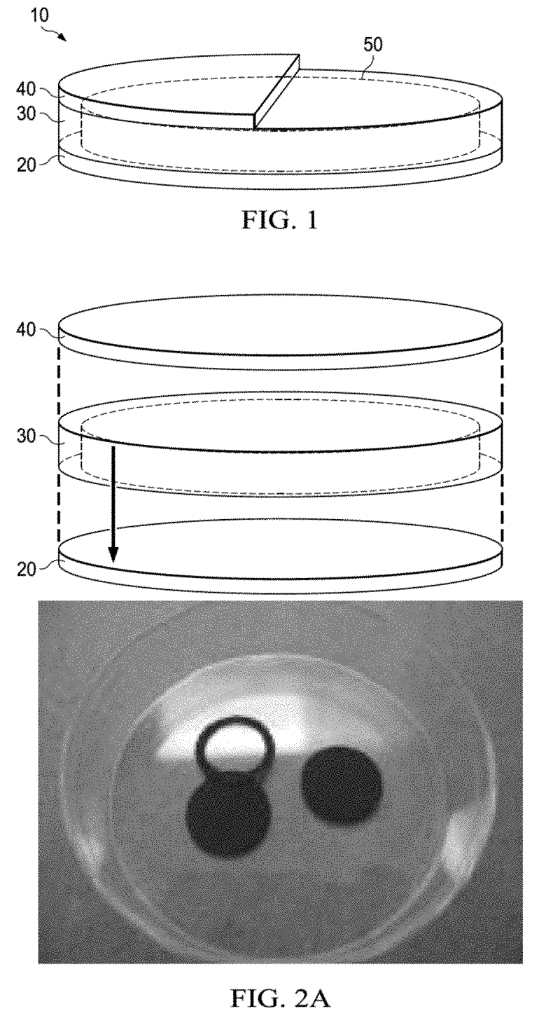

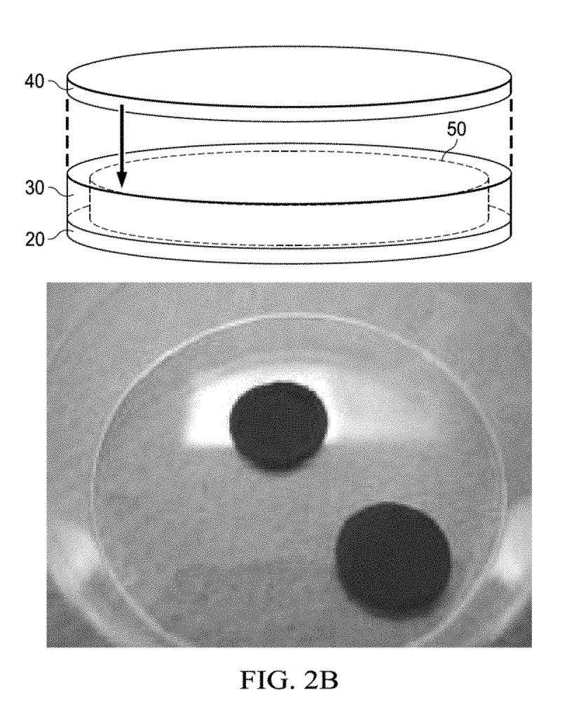

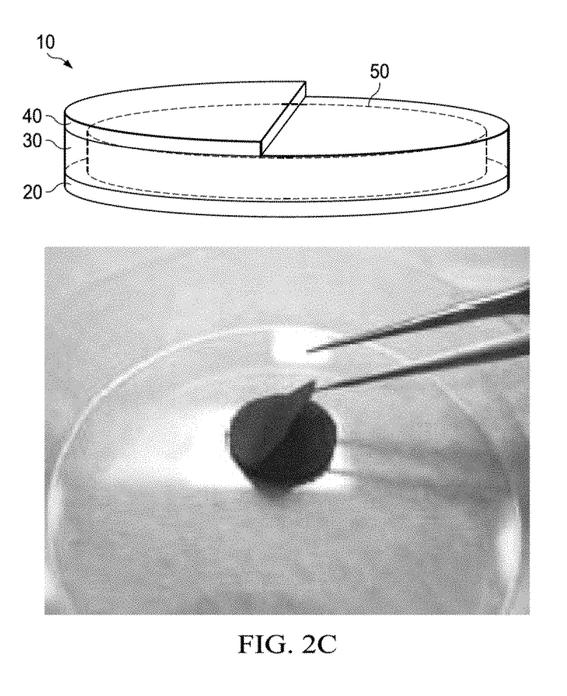

Referring now to an example core-shell cathode, FIG. 1 is a schematic diagram of Li—S core-shell cathode 10. Core-shell cathode 10 includes first layer 20, O-ring 30, and second layer 40, which contain sulfur-based core 50. Core-shell cathode 10 may be assembled as depicted in FIG. 2A, FIG. 2B, and FIG. 2C. First, as shown in FIG. 2A, first and second layers 20 and 40 and O-ring 30 are cut or otherwise formed in their final dimensions from a thin, porous material. Next, as shown in FIG. 2B, O-ring 30 is pressed onto first layer 20. Sulfur-based core 50 is then placed inside O-ring 30. Sulfur-based core 50 may include a sulfur-based material dissolved or suspended in a blank electrolyte or other liquid or gel. Finally, as shown in FIG. 2C, second layer 40 is placed on top of O-ring 30 to complete the shell and enclose sulfur-based core 50.

The shell of a core-shell cathode, such as first and second layers 20 and 40 and O-ring 30 or core-shell cathode 10, may be formed from thin, electrically conductive, porous material layers, such as carbon paper.

In general, a carbon shell may be formed from any electrically conductive, porous carbon material, such as carbon nanofibers and carbon nanotubes, including single-walled carbon nanotubes, double-walled carbon nanotubes, and multi-walled carbon nanotubes. The porous carbon material may also include graphene and carbon powders. The carbon material may be with or without a binder.

The electrically conductive, porous shell may also be formed from a conductive polymer, such as polyaniline, or a porous metal, such as nickel foam. Any shell material may be composited with other materials or it may be functionalized, or both to improve its electrochemical characteristics or to enhance its mechanical strength.

The sulfur-based core of the core-shell cathode may include sulfur, a sulfur compound, a sulfur-based composite material, or any combination thereof. Sulfur may include elemental sulfur, typically in the form of particles, such as microparticles or nanoparticles. Elemental sulfur includes crystalline sulfur, amorphous sulfur, precipitated sulfur, and melt-solidified sulfur.

Sulfur compounds may include lithium sulfides or polysulfides of the types typically formed during operation of a Li—S battery, such as Li₂S₂, Li₂S, or Li₂Sₙ, 4≤n≤8. Sulfur compounds may also include sulfur oxides and organic materials containing sulfur. These sulfur compounds may be provided in the form of particles, or as a liquid or gel catholyte. Catholyte portions of the sulfur-based core may also be formed during operation of the Li—S battery.

The sulfur-based core of the core-shell cathode may also contain more structured sulfur composites, such as sulfur-carbon composites, including those that contain sulfur at a micro or nano-scale within carbon pores. The sulfur-based core may include a sulfur-carbon composite, a sulfur-polymer composite, a sulfur-sulfur compound composite, or any combinations thereof.

Any combinations of any of the foregoing types of elemental sulfur, sulfur compounds, or sulfur composites may also be used in the sulfur-based core.

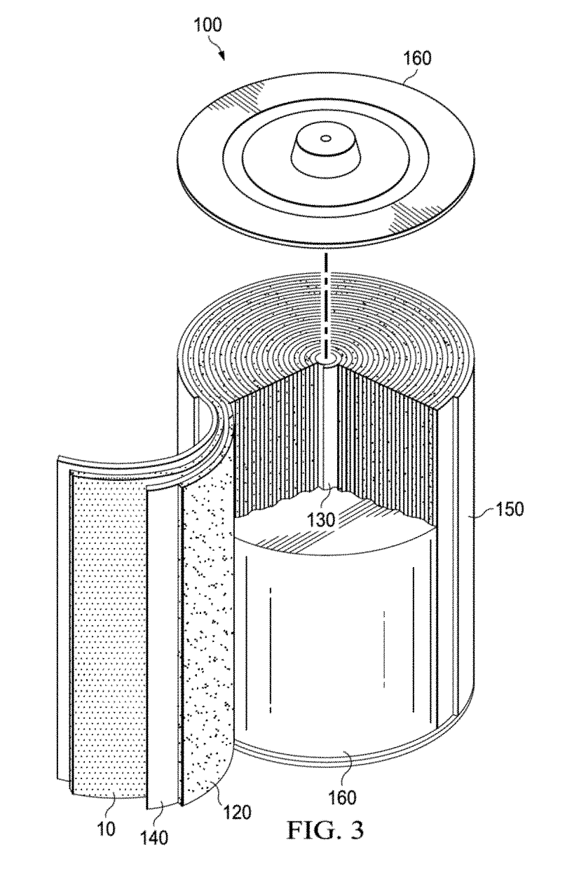

Referring now to an example battery containing a core-shell cathode, FIG. 3 is a schematic diagram of a jelly-roll Li—S battery 100 including core-shell cathode 10, anode 120, electrolyte 130, separator 140, casing 150 and contacts 160. Other battery configurations, such as coin cells and prismatic cells, are also compatible with a core-shell cathode.

Anode 110 may be any anode suitable for use in a Li—S battery, including, but not limited to, lithium metal, or a current collector coated with an anode active material.

Separator 120 may be an electrically insulative separator, such as a polymer, gel, or ceramic.

A further separator to trap polysulfides may be included between cathode 10 and separator 120. This separator may be conductive on one side facing toward the cathode. For instance, it may be a polyethylene glycol (PEG)-supported MPC-coated separator (MPC/PEG-coated separator). However, given the ability of the shell to trap polysulfides, a trap is often unnecessary.

If electrolyte 130 includes a solid electrolyte, separator 120 may include the solid electrolyte. If electrolyte 130 includes a liquid or gel electrolyte, it may permeate separator 120, cathode 10, anode 110, or any combination thereof. The electrolyte may include combinations of liquid, gel, and solid electrolytes.

Electrolyte 130 may be non-aqueous to avoid deleterious effects of water. For instance, if may include a nonionic liquid or an ionic liquid, such an organic solvent or mixture of organic solvents. The electrolyte may further include an ionic lithium electrolyte salt, such as, LiSCN, LiBr, LiI, LiClO4, LiAsF₆, LiCF₃SO₃, LiSO₃CH₃, LiBF₄, LiB(Ph)₄, LiPF₆, LiC(SO₂CF₃)₃, LiN(SO₂CF₃)₂, and combinations thereof.

Electrolyte 130 may form a catholyte after entering core-shell cathode 10. Typically a catholyte contains one or more of a lithium sulfide or a lithium polysulfide of the general formula Li₂Sₙ, 1≤n≤8. The polysulfide may have a nominal formula of Li₂S₆. The catholyte may also contain a material in which the polysulfide is dissolved. For example, the catholyte may also contain LiCF₃SO₃, LiTFSI, LiNO₃, dimethoxy ethane (DME), 1,3-dioxolane (DOL), tetraglyme, other lithium salt, other ether-based solvents, and any combinations thereof.

Li—S batteries of the present disclosure may contain contacts, a casing, or wiring. In the case of more sophisticated batteries, they may contain more complex components, such as safety devices to prevent hazards if the battery overheats, ruptures, or short circuits. Particularly complex batteries may also contain electronics, storage media, processors, software encoded on computer readable media, and other complex regulatory components. Batteries that contain more than one electrochemical cell and may contain components to connect or regulate these multiple electrochemical cells.

Li—S batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

Li—S batteries and core-shell cathodes of the present disclosure may have at least one or any combinations of the following properties:
A sulfur loading in the core-shell cathode of at least 4 mg/cm², at least 5 mg/cm², at least 10 mg/cm² at least 15 mg/cm², at least 20 mg/cm², or at least 25 mg/cm²;
A sulfur loading in the core-shell cathode of between 5 mg/cm² and 30 mg/cm², between 10 mg/cm² and 30 mg/cm², between 15 mg/cm² and 30 mg/cm², between 20 mg/cm² and 30 mg/cm², or between 25 mg/cm² and 30 mg/cm²;
A sulfur loading in the core-shell cathode of at least 40 wt %, at least 50 wt %, or at least 60 wt %, based on total weight of the core and shell;
A sulfur loading in the core-shell cathode or at least 4 mg/cathode, at least 5 mg/cathode, at least 10 mg/cathode, at least 15 mg/cathode, at least 20 mg/cathode, at least 25 mg/cathode, or at least 30 mg/cathode;
A volumetric sulfur loading in the core-shell cathode of at least 3 g/cm³, at least 4 g/cm³, at least 5 g/cm³, or at least 6 g/cm³;
An areal capacity of the core-shell cathode of at least 5 mAh/cm², at least 10 mAh/cm², at least 15 mAh/cm², at least 20 mAh/cm², or at least mAh/cm²;
A volumetric capacity of the core-shell cathode of at least 500 mAh/cm³, at least 550 mAh/cm³, or at least 600 mAh/cm³;
A gravimetric capacity based on the whole cathode of at least 600 mAh/g, at least 650 mAh/g, or at least 700 mAh/g;
A specific capacity of at least 1600 mAh/g, at least 1630 mAh/g, or at least 1632 mA h/g;
Peak sulfur utilization of the sulfur in the core-shell cathode of at least 90%, at least 95%, or at least 97%, when cycled at any C-rate between C/20 and C/5;
A peak discharge capacity of at least 700 mAh/g, at least 750 mAh/g, at least 800 mAh/g, at least 850 mAh/g, or at least 870 mAh/g at C/5 rate;
The electrically conductive, porous shell may readily transfer electrons both and electrolytes to continuously utilize the enclosed sulfur-based core;
The electrically conductive, porous shell provides fast electron pathways and improves the reaction accessibility of the sulfur-based core, which improves its electrochemical reversibility during repeated redox conversions as the rechargeable battery is cycled;
The electrically conductive, porous shell provides a strong tortuosity, which deters polysulfide diffusion and, therefore, traps polysulfides formed from the sulfur-based core within the shell;
The electrically conductive, porous shell may withstand the high stress associated with the volume change during cycling from either the sulfur-based core or the trapped polysulfides;
A dynamic capacity retention rate of at least 50%, at least 60%, or at least 70% with a cathode having a sulfur loading of at least 4 g/cm² or 3 g/cm³;
A static capacity retention of at least 75%, at least 80%, or at least 85% over a three-month rest period; and
A capacity fade of less than 0.1%, less than 0.08%, or less than 0.07% per day over a three-month rest period.

### EXAMPLES

The following examples are provided to further illustrate specific embodiments of the disclosure. They are not intended to disclose or describe each and every aspect of the disclosure in complete detail and should not be so interpreted.

### Example 1: Structural and Chemical Analysis Techniques

Microstructural, morphological, and elemental analyses in these Examples were carried out with a STEM or a field emission scanning electron microscope (FE-SEM). Both microscopes were equipped with EDX for detecting elemental signals and collecting elemental mapping signals. Both uncycled and cycled cathodes were retrieved inside an argon-filled glove box, rinsed with a salt-free blank electrolyte for 5 min, dried with a Kimwipe paper, and transported into an argon-filled sealed vessel. The prepared samples were subjected to microstructural and elemental analysis within 30 min of preparation. The rinsing solution had 10 mL of 1:1 volume ratio of DME/DOL. The specific surface area and porosity analysis were calculated with, respectively, the 7-point Brunauer-Emmett-Teller method and the t-plot method. Samples were analyzed with an automated gas sorption analyzer at 77K. Raman microscopy was performed with a WITEC Alpha 300 S micro-Raman System using a 488 nm Ar laser and a 100× objective.

### Example 2: Fabrication of a Core-Shell Cathodes and Conventional Sulfur Cathodes

FIG. 1, FIG. 2A, FIG. 2B, and FIG. 2C show the components and configuration of the core-shell cathode of this Example. The layers and O-ring were farmed from carbon paper having an interwoven carbon nanotube (CNT) and a carbon nanofiber (CNF) network. The entangled CNT/CNF network creates a containment building that has a porous core for storing the active material.

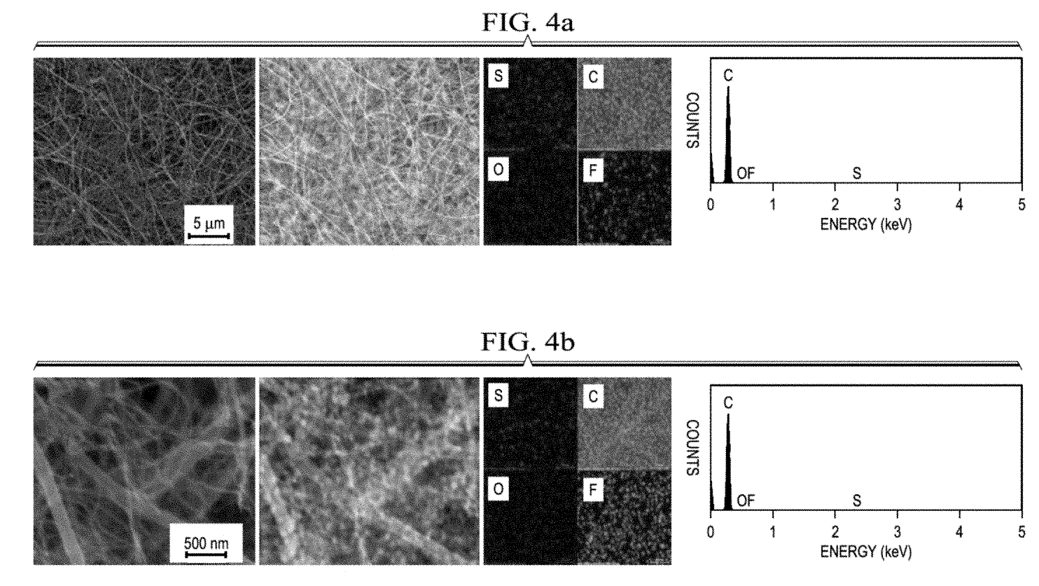

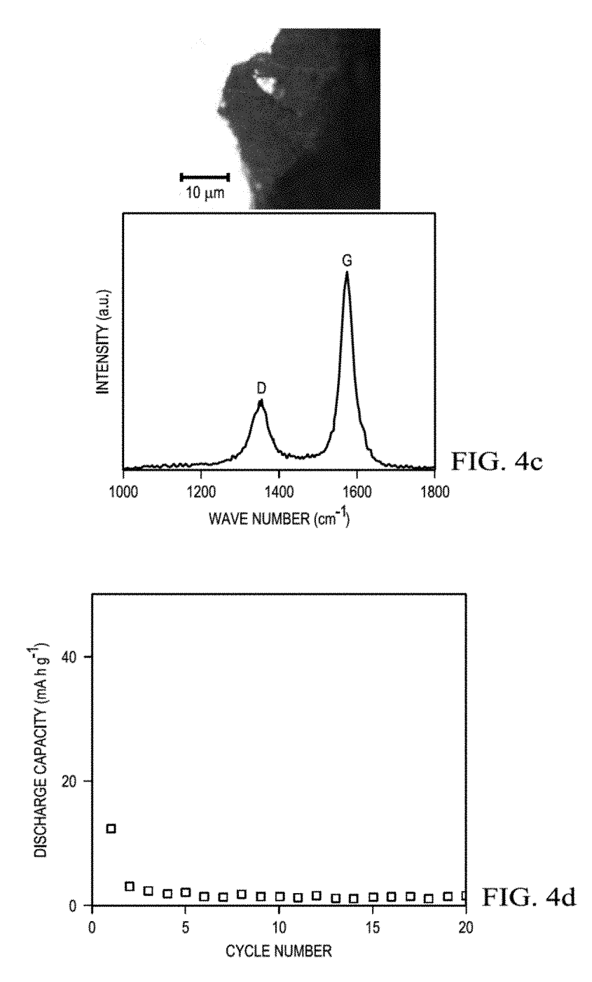

The carbon paper was analyzed further and the results are presented in FIG. 4. SEM and EDX were used to analyze the CNT/CNF composite network in the carbon paper. (FIG. 4A and FIG. 4B.) The interwoven CNTs are entangled in the long-range CNF framework, which builds up a continuous electron pathway and a successive electrolyte channels. Raman spectrum showed a high intensity ratio of G band to D band. (FIG. 4C.) The high graphitization level of the carbon paper indicated its fast electron-transfer capability. The cycling performance of the carbon paper indicated its high electrochemical and chemical stability in a Li—S electrochemical cell. (FIG. 4D.)

In order to focus on the effect of the macro-scale core-shell cathode configuration and minimize any micro or nano-scale effects of carbon pores on sulfur, the carbon paper used had a low specific surface area of 81 m²/g.

The core-shell cathode was constructed in an argon-filled glove box. Two layers of carbon paper both with an area of 1 cm² and a diameter of 1.13 cm were formed. (FIG. 2A.) An O-ring of carbon paper with an outer diameter of 1.13 cm and inner diameter of 0.95 cm was also formed. (FIG. 2A.) One layer of carbon paper with an area of 1 cm² was arranged at the bottom, acting as the current collector. (FIG. 2B.) The carbon-paper O-ring was subsequently directly pressed onto it, which created a volume for storing the sulfur-based core. (FIG. 2B.) The sulfur-based core was prepared by dispersing micron-sized sulfur powder (325 mesh, 99.5% purity) in a blank electrolyte for 10 min. The sulfur to electrolyte ratio was 1:10. The cloudy suspension was subsequently added into the porous space of the carbon shell, followed by covering it by the upper carbon paper and pressing. (FIG. 2B and FIG. 2C.) No binder was used during core-shell cathode fabrication.

By adjusting the thickness of the O-ring, the core-shell cathodes with sulfur loadings of 4, 6, 8, 10, 20, and 30 mg/cm² were prepared. The core-shell cathodes had a sulfur loading of up to 70 wt % based on total weight of the core and shell. The volumetric sulfur loadings in the core-shell cathodes with areal loadings of 4, 6, 8, 10, 20, and 30 mg/cm² are 3.6, 3.7, 3.7, 4.2, 5.6, and 6.3 g/cm³, respectively)

A conventional sulfur cathode that was used in the control cells in these Examples contained 70 wt. % sulfur powder, 15 wt % Super P carbon black, and 15 wt % polyvinylidene fluoride (PVDF, solution viscosity: 550 mPa). The cathode active material mixtures are stirred in N-methy-1-2-pyrolidone for two days into a viscous paste and then tape-casted onto an aluminum-foil current collector with an automatic film applicator at a traverse speed of 50 mm/s. The electrode was dried at 50° C. in an air oven overnight, roll-pressed, and cut into circular disks with an area of 1 cm². The conventional sulfur cathodes had an average sulfur loading of 4 mg/cm² and a sulfur content of 70 wt % based on total weight of the cathode, excluding the current collector. The loading of the conventional sulfur cathodes was fixed at 4 mg/cm² due to the poor cyclability and high instability at higher sulfur loadings.

Core-shell cathode and conventional cathode fabrication parameters and properties are summarized in Table 1.

TABLE 1
Core-Shell Cathode Parameters

| | Sulfur loading | Sulfur mass | Sulfur content |
|---|---|---|---|
| Parameters | [mg/cm²] | [mg/electrode] | [wt %] |
| CS4 cathode | 4.0 | 4.0 | 45.45 |
| conventional4 | 4.0 | 4.0 | 70.00 |
| cathode | | | |
| CS6 cathode | 6.0 | 6.0 | 51.72 |
| CS8 cathode | 8.0 | 8.0 | 55.56 |
| CS10 cathode | 10.0 | 10.0 | 58.14 |
| CS20 cathode | 20.0 | 20.0 | 65.79 |
| CS30 cathode | 30.0 | 30.0 | 68.81 |

Calculations in Table 1 for the conventional cathode excluded the current collector and included only the sulfur-based material, carbon black, and PVDF. If the current collector is included, as it normally would be given that it is a required component for conteventional cathode, the sulfur content wt % drops to only 37.81.

### Example 3: Microstructural and Elemental Analyses of Core-Shell Cathodes Carbon Paper Shell

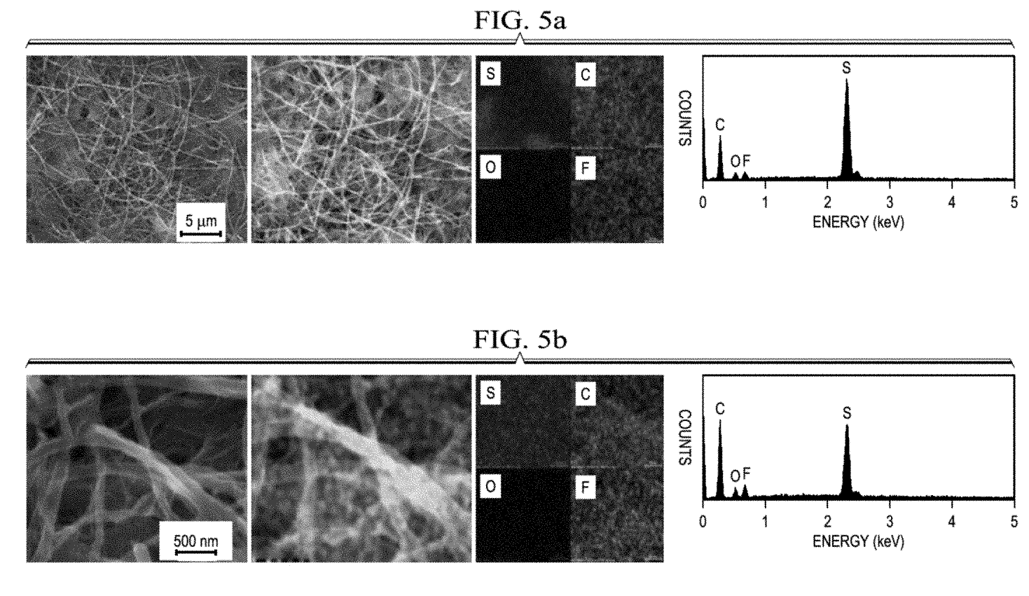

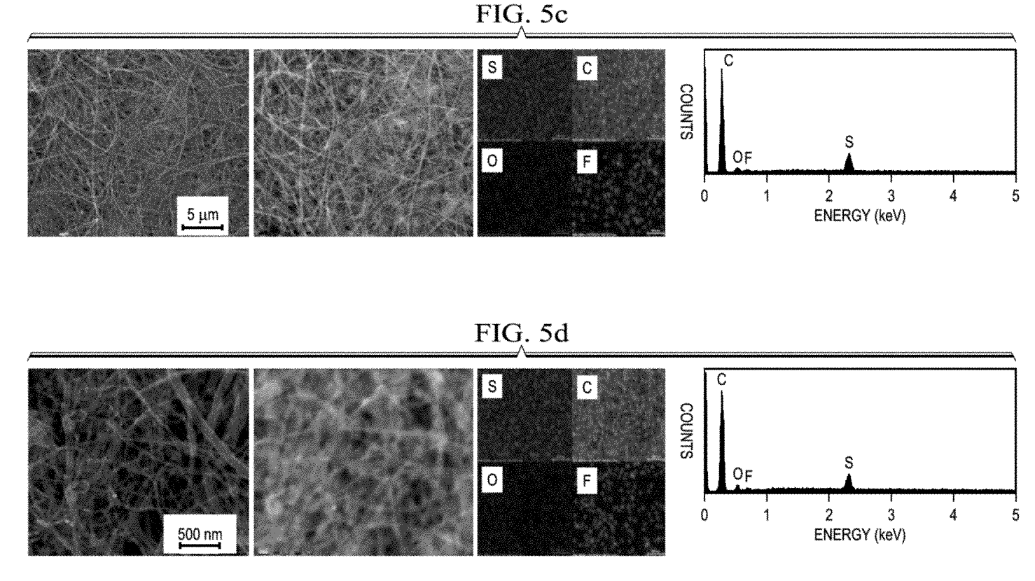

FIG. 5 shows SEM images and the corresponding EDX analysis of the carbon paper shell of an uncycled core-shell cathode that was allowed to rest for 6 hours after assembly. The core-shell cathode had a 4 mg/cm² sulfur-based core.

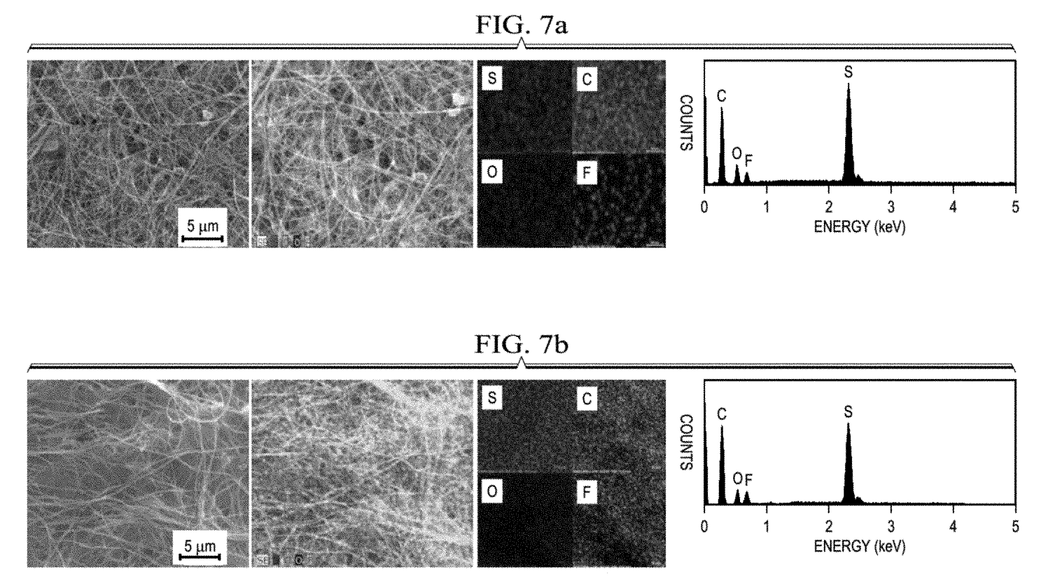

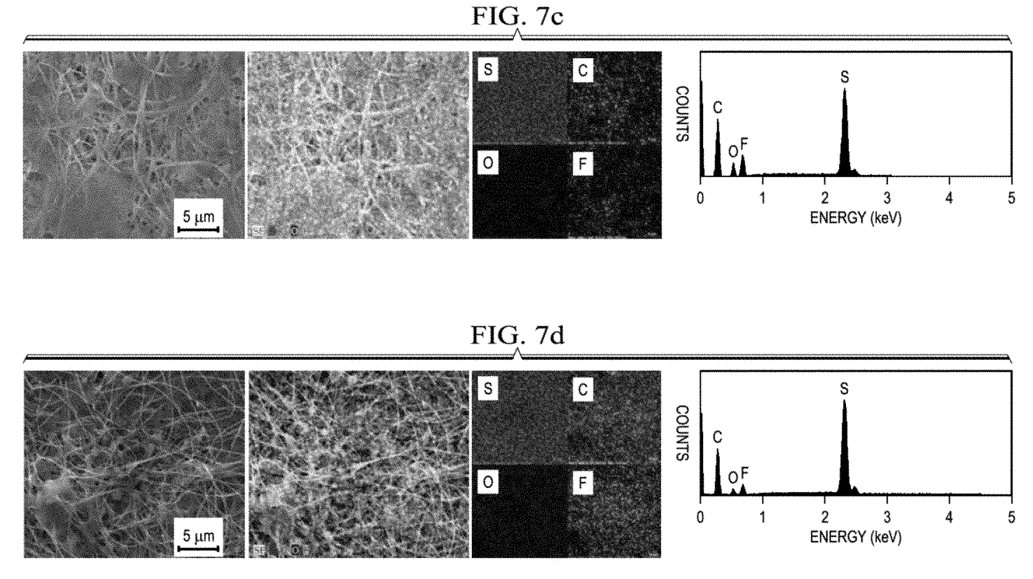

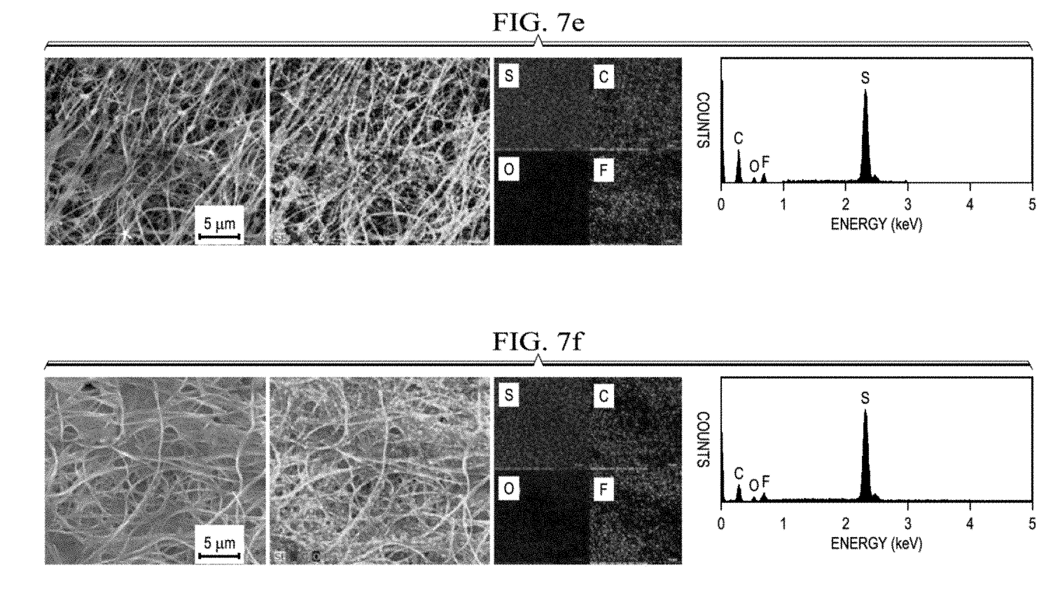

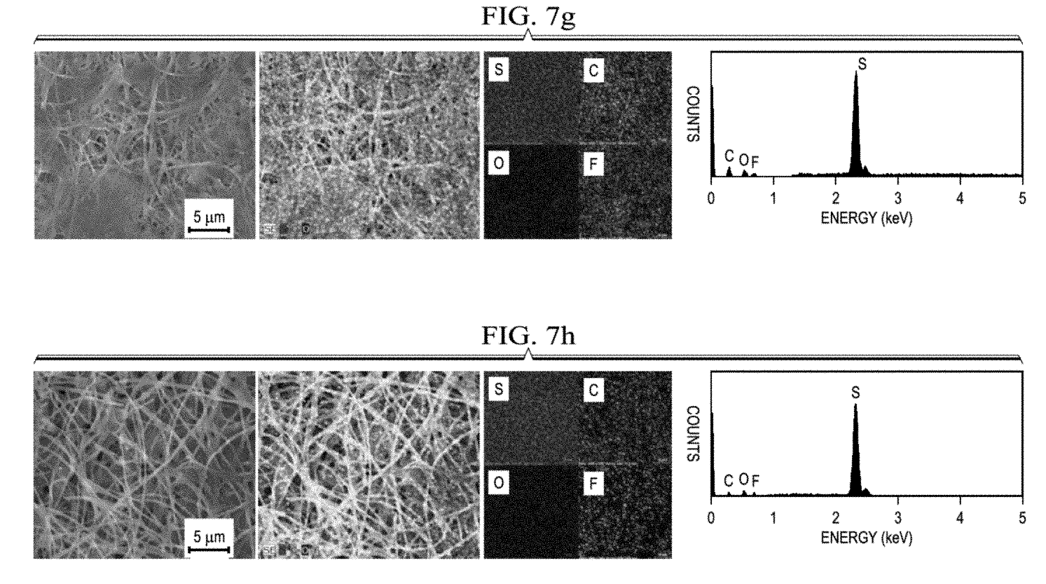

As the SEM images show, the carbon paper has interwoven CNTs entangled in a CNF skeleton, which smoothly shields the sulfur-based core. The embedded sulfur-based core, on the other hand, illustrates the high intensity of sulfur signals in the elemental mapping results and the EDX spectra. (FIG. 7). Such core-shell cathode architecture provides the following advantages in boosting the electrochemical characteristics of Li—S cells: (i) the CNT/CNF structure provides fast electron pathways and improves the reaction accessibility of the sulfur-based core so as to ensure its electrochemical reversibility during repeated redox conversions as the rechargeable battery is cycled; (ii) the interconnected CNT/CNF network introduces a strong tortuosity for deterring polysulfide diffusion from the cathode and, therefore, traps polysulfides formed from the sulfur-based core within the carbon paper shell; (iii) after trapping polysulfides, the carbon paper shell transfers electrons and electrolytes to continuously utilize the enclosed sulfur-based core and also withstands the high stress associated with the volume change from either the sulfur-based core or the trapped polysulfides; (iv) the core-shell cathode has better architectural and electrochemical stability than a conventional cathode containing carbon particles, polymer binders, and aluminum-foil current collectors.

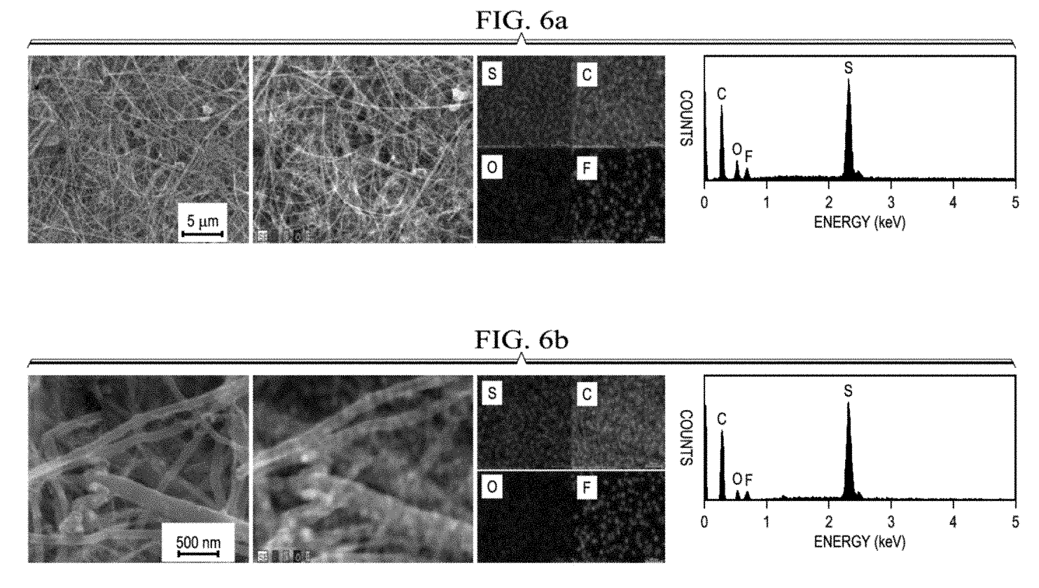

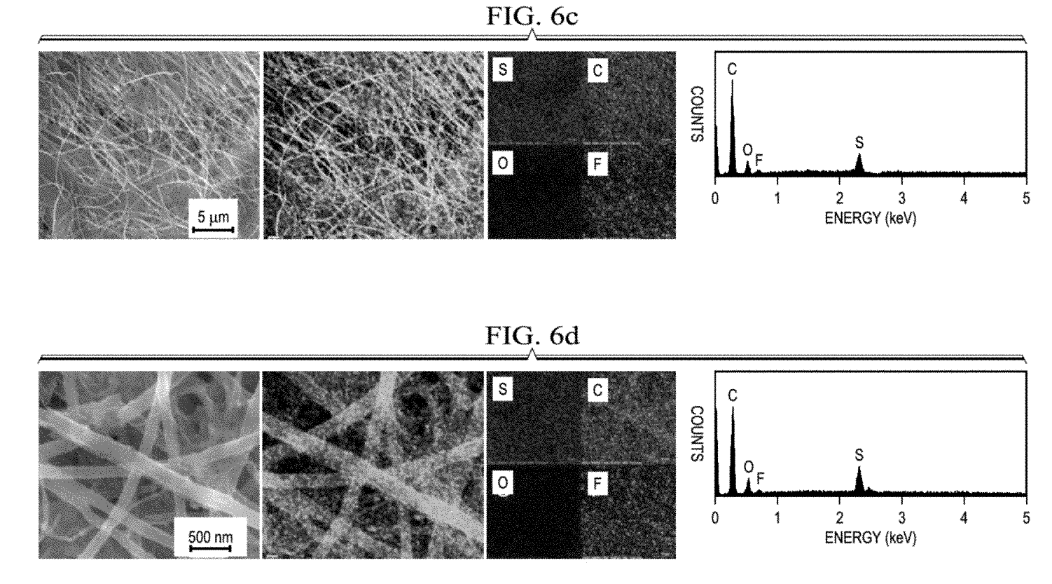

FIG. 6 shows SEM/EDX analysis of the carbon paper shell of a cycled core-shell cathode after 100 cycles, followed by charging at 3V. The core-shell cathode had a 4 mg/cm² sulfur-based core. After cycling, the carbon paper shell of the cathode maintains almost the same morphology as prior to cycling. (Compare FIG. 5 and FIG. 6.) In particular, it remains characterized by interwoven CNT/CNF networks and unblocked porous channels. Corresponding elemental analysis shows strong elemental sulfur signals, which are very similar to those of the uncycled cathode. SEM/EDX analysis depicts suppressed polysulfide diffusion and elimination of cathode passivation.

In order to further examine polysulfide diffusion, the SEM/EDX analysis included analysis at the both centers (FIG. 5C, FIG. 5D, FIG. 6A, and FIG. 6B) and edges (FIG. 5A, FIG. 5B, FIG. 6C, and FIG. 6D) of the carbon paper of cycled and uncycled core-shell cathodes. The carbon paper O-ring is located near the edges, but not the center of the core-shell cathodes. As expected, both before and after cycling, the carbon paper near the edges of the core-shell cathode showed very limited elemental sulfur signals, indicating that substantial polysulfide diffusion toward the edge of the core-shell cathode did not occur. Such low polysulfide diffusion confirms that the core-shell cathode is a suitable structure for limiting polysulfide diffusion.

The effects of different sulfur loadings in core-shell cathodes were also analyzed via SEM/EDX analysis of cycled core-shell cathodes after 100 cycles, followed by charging at 3V. (FIG. 7.) Analysis of the outer surface of the carbon paper over a range of sulfur loadings (4 mg/cm² (FIG. 7A), 6 mg/cm² (FIG. 7B), 8 mg/cm² (FIG. 7C), 10 mg/cm² (FIG. 7D), 20 mg/cm² (FIG. 7E), 30 mg/cm² (FIG. 7F)) showed that polysulfides remained trapped in the carbon paper shell, even as sulfur loading increased. In addition comparative analysis of the outer surface of the carbon paper and the inner surface adjacent the sulfur-based core at a sulfur loading of 4 mg/cm² (FIG. 7A and FIG. 7G), and 30 mg/cm² (FIG. 7F and FIG. 7H) showed far more intense sulfur signals on the inner surface of the carbon paper at both sulfur loadings, confirming that polysulfides form and contact the carbon paper, but cannot significantly diffuse out of the shell during battery cycling.

### Sulfur-Based Core

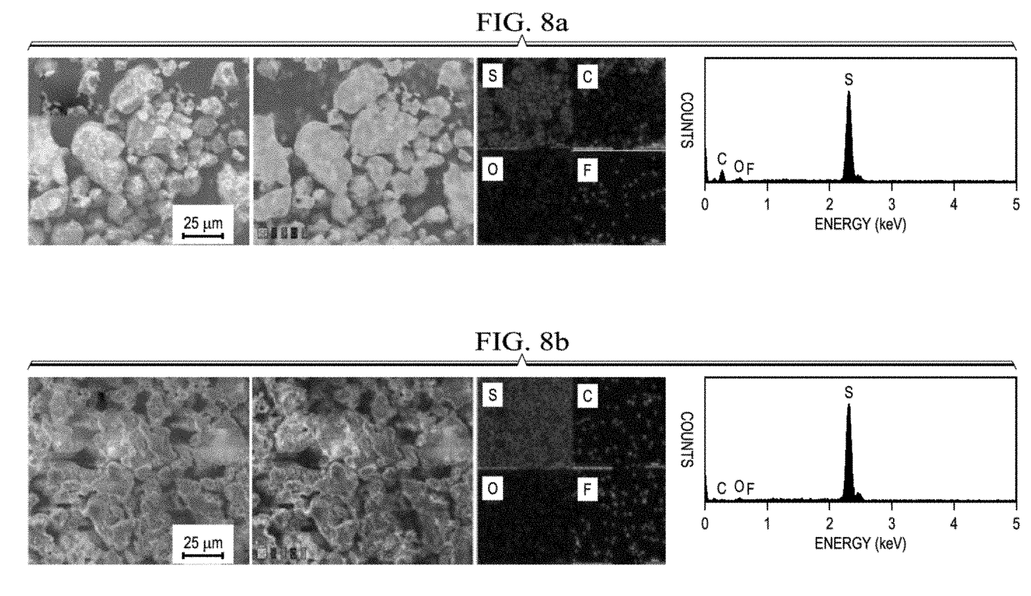

The sulfur powder used to form the sulfur-based core was examined and characterized prior to formation of the core-shell cathode, before cycling of the cathode, and after cycling. The powder contained agglomerated particles and clusters larger than 50 μm prior to formation of the core-shell cathode and prior to cycling. (FIG. 8A and FIG. 8B.)

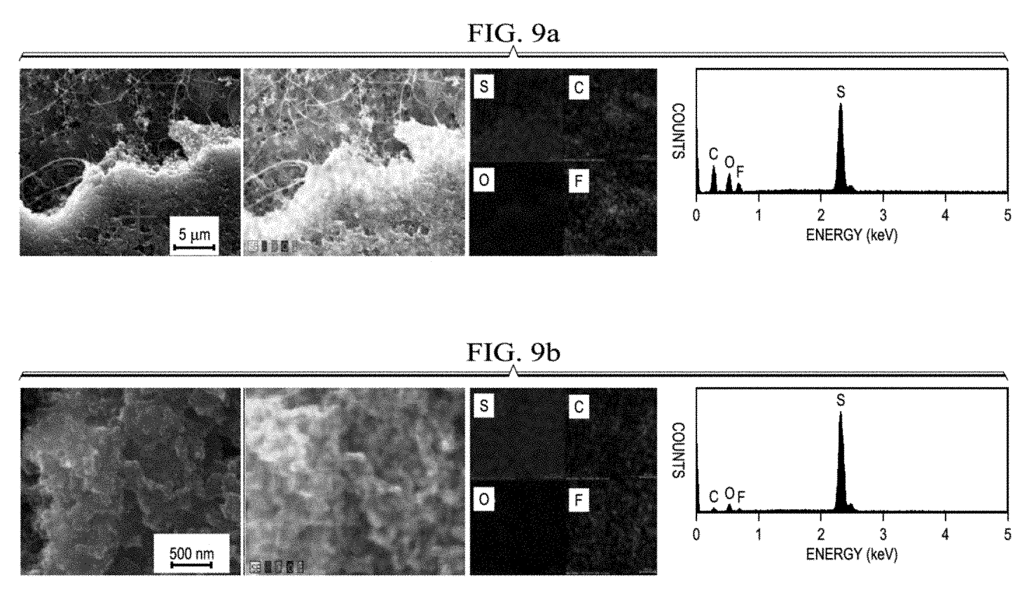

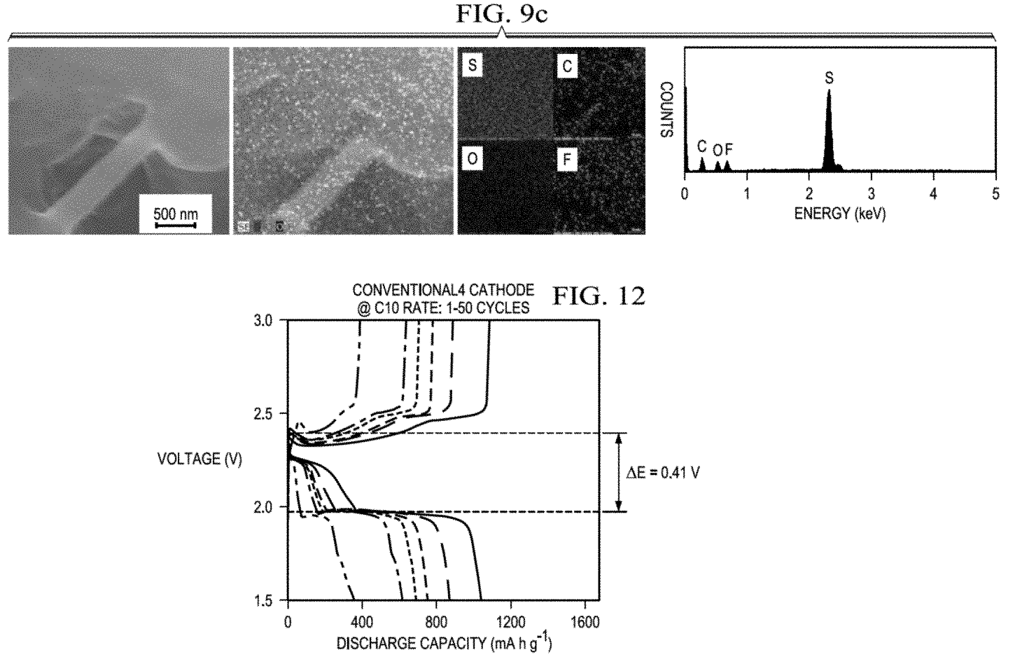

The cycled sulfur-based core shown in FIG. 9 was prepared by peeling off the upper carbon shell from a cycled core-shell cathode and then removing a part of the sulfur-based core by a blade. An obvious sulfur cluster and a strong EDX sulfur signal remained after cycling for 100 cycles, followed by charging at 3V, indicating that the sulfur-based core is well-stabilized by the shell in the core-shell cathode during cycling. (FIG. 9.) In contrast to the uncycled sulfur-based core (FIG. 8B, which is characterized by large sulfur particles and aggregated clusters, the cycled sulfur-based core contains small active-material particles tightly sealed within the carbon shell, a result of solid(sulfur)-liquid(polysulfides)-solid(sulfides) phase transformations. During the redox conversions, the formation of polysulfide intermediates allows the active material to occupy an electrochemically more favorable position. This in-situ cathode active material rearrangement ensures smooth ion and electron transport for efficient electrochemical reactions. Such an in-situ rearrangement is possible only when polysulfides are enclosed and well-retained in the area of the cathode. Otherwise, the polysulfide diffusion leads to a negative rearrangement, which causes the fast capacity fade and electrode degradation.

Moreover, it is known that the polysulfides, especially Li₂Sₓ with x≥4, are readily solubilized into the DOL/DME-based electrolyte. The dissolved polysulfides are electrochemically active and function as a catholyte, which is enclosed within the cathode so that it may assist with the electrochemical conversion of the sulfur-based core. Therefore, the cathode active material rearrangement and enclosed polysulfides observed in microstructural analysis may raise the electrochemical stability and the utilization of the cathode active material in the sulfur-based core.

### Example 4: Fabrication of Li—S Batteries

Battery chemistries and electrochemical analyses in these Examples were based on CR2032-type coin cells. The experimental Li—S batteries were assembled with core-shell cathodes, a polymeric separator, a lithium anode, a nickel foam spacer, and a blank electrolyte. The blank electrolyte contained 1.85 M LiCF₃SO₃ salt and 0.1 M LiNO₃ co-salt in a 1:1 volume ratio of DME:DOL. The same blank electrolyte was used in the control battery that had a conventional sulfur cathode.

The polysulfide-trap Li—S batteries were assembled with the cathode, a first layer of a polymeric separator, a carbon paper, a second layer of a polymeric separator, Li anode, and a nickel foam spacer in CR2032 coin-type cells with the same blank electrolyte. The carbon paper inserted in between the two layers of separators was used as a polysulfide trap for the qualitative evaluation of the presence or absence of severe polysulfide diffusion. The core-shell cathodes were used in the polysulfide-trap Li—S batteries cells in order to demonstrate their excellent polysulfide-retention capability. In contrast, the conventional cathodes were used in the control polysulfide-trap Li—S batteries to show typical dynamic and static polysulfide diffusions as a comparison.

### Example 5: Electrochemical and Battery Analysis Techniques

The assembled Li—S batteries were allowed to rest for 6 h before investigating the dynamic battery chemistries. The static battery chemistries were studied using the uncycled Li—S batteries after resting for half, one, two, and three months.

EIS data were collected in the frequency range of 106 to 10-1 Hz and at an amplitude perturbation of 5 mV. EIS data were obtained with a computer-interfaced impedance system with a potentiostat coupled with an impedance analyzer. Cyclic voltammograms (CV) were scanned at 0.05 mV/s in the potential range of between 1.5 and 3.0 V. CV measurements were evaluated with a universal potentiostat. Discharge and charge profiles and electrochemical cycling data that show the dynamic battery chemistries were collected at C/20-C/2 rates in the voltage window of 1.5-3.0 V. The static battery chemistries were investigated at a C/10 rate in the same voltage window after various rest periods. Electrochemical data were collected with a programmable battery cycler.

### Example 6: Dynamic Testing of Li—S Batteries with Core-Shell Cathodes

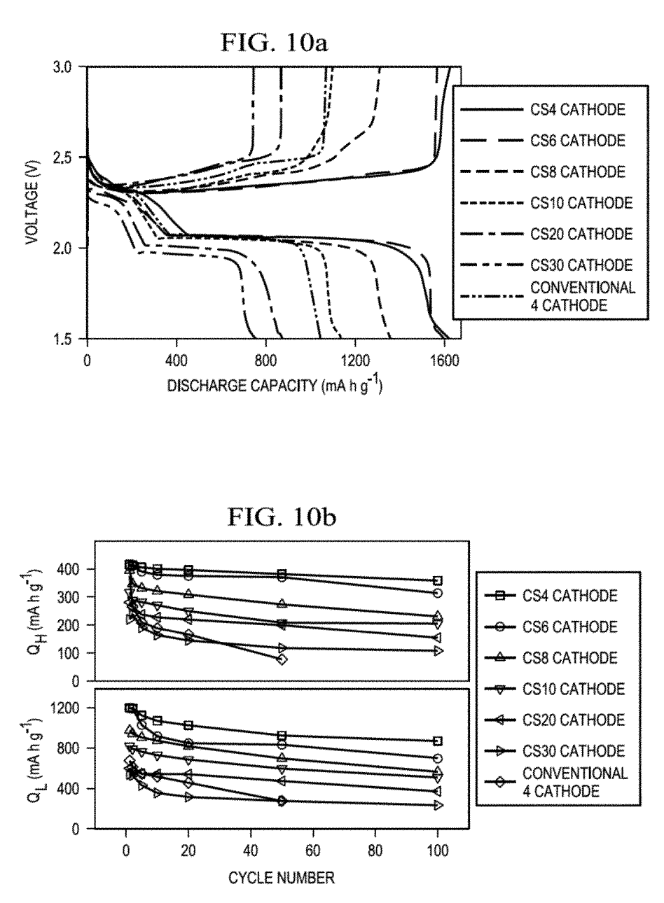

Dynamic testing of Li—S battery properties was carried out during cycling of those batteries. Dynamic reactions were first characterized by the discharge and charge curves at a C/10 rate. (FIG. 10A). The discharge and charge curves show two distinct discharge plateaus and two continuous charge plateaus. The upper discharge plateau corresponds to the reduction of sulfur to polysulfide intermediates that are easily dissolved into the liquid electrolyte and diffuse out from a conventional cathode. The lower discharge plateau is caused by the conversion of polysulfide intermediates to a mixture of Li₂S₂ and Li₂S, which precipitate as solid products on available electrode surfaces due to their insolubility in the electrolyte. The two continuous charge plateaus represent the oxidation reactions reverting back from a mixture of Li₂S₂ and Li₂S to polysulfide intermediates, such as Li₂S₈ and sulfur. The complete redox reactions demonstrate that the core-shell cathodes support their high-loading sulfur-based cores with an efficient electrochemical-reaction capability.

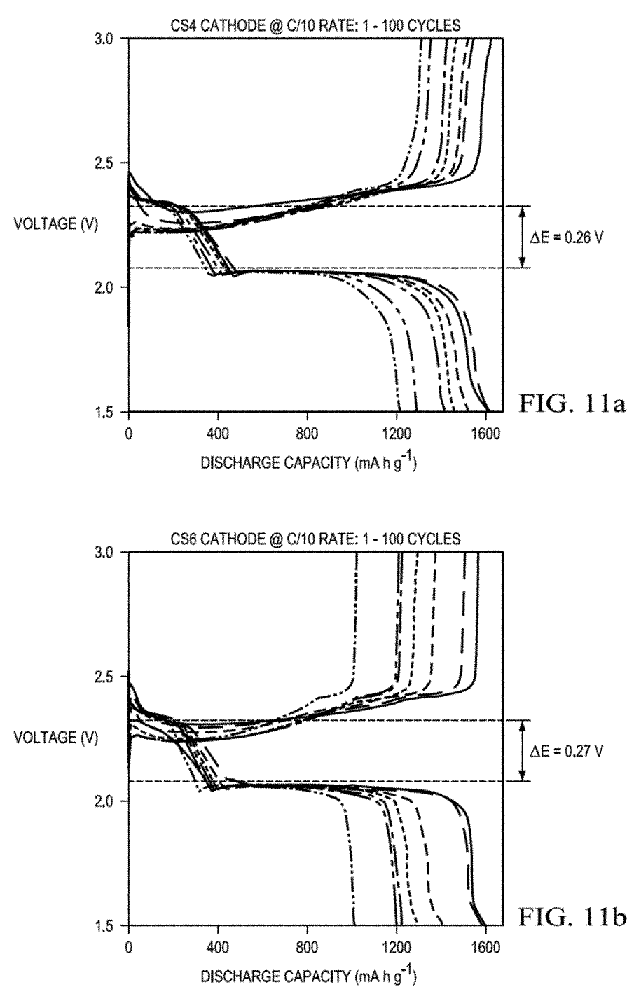

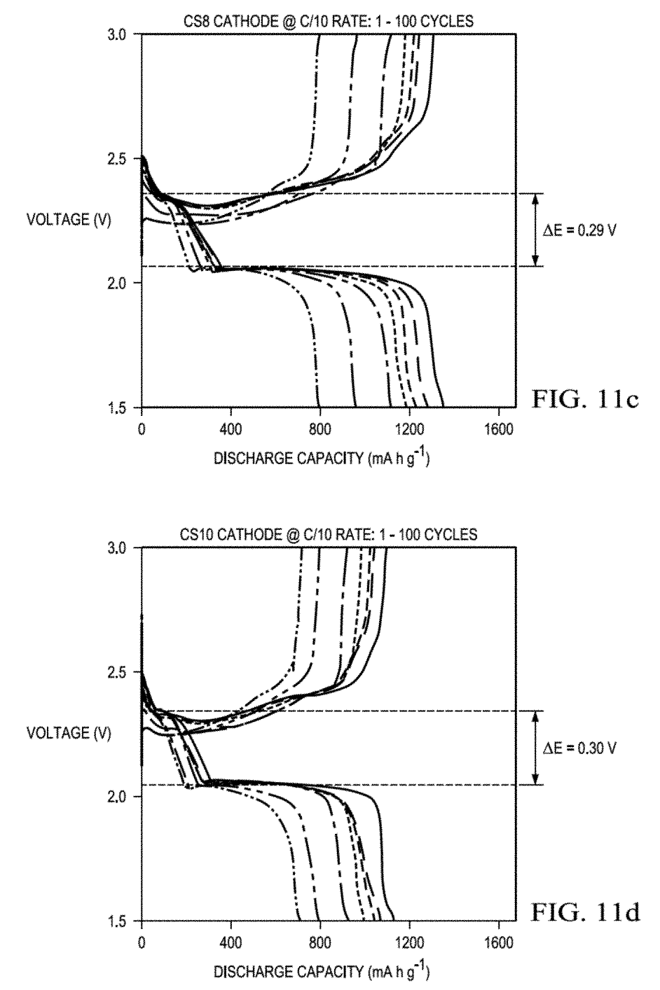

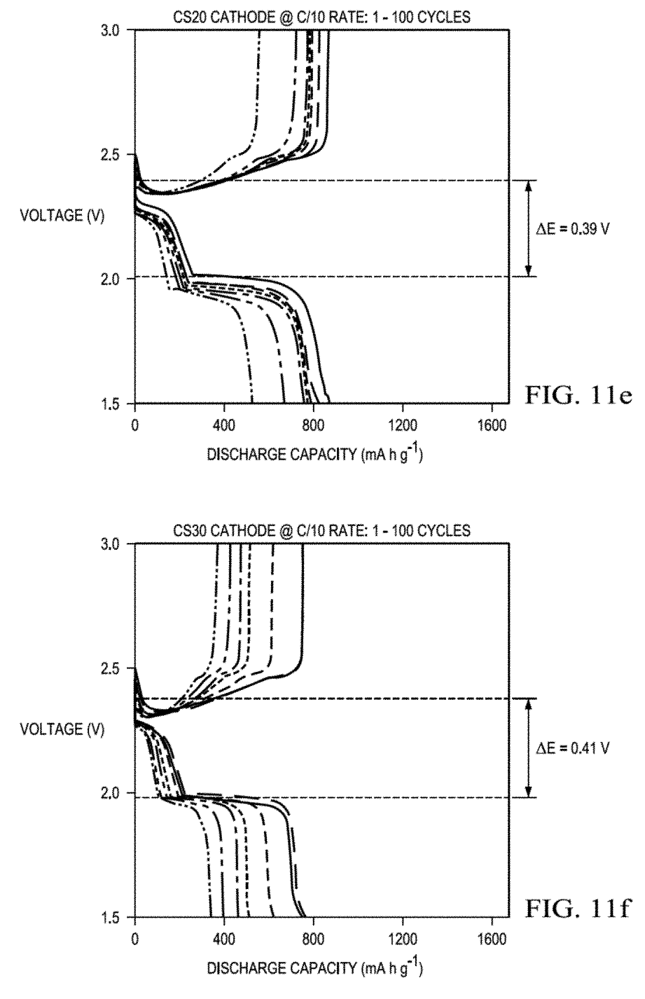

Such fast redox reaction kinetics brought by the core-shell cathodes are reconfirmed by their low voltage hysteresis over 100 cycles. (FIG. 11 and FIG. 12.) The voltage hysteresis was evaluated by considering polarization (ΔE) between the discharge and charge curves obtained at a 50% depth of discharge. The ΔE revealed a low value of 0.26 V for the Li—S batteries employing a core-shell cathode (FIG. 11A) while the ΔE of the conventional sulfur cathodes at the same sulfur loading presented a much higher value of 0.41 V (FIG. 12). As the sulfur loading increases from 4 to 30 mg/cm² in core-shell cathodes, Li—S batteries containing these cathodes continued to exhibit reasonably low ΔE values of at 0.26-0.41 V. (FIG. 11A-FIG. 11F.) This demonstrates the fast redox reaction kinetics of core-shell cathodes with increasingly high sulfur loadings. In contrast, Li—S batteries with conventional cathodes experienced fast capacity fade in only 50 cycles and increasing polarization. (FIG. 12).

In addition, the discharge and charge curves for the Li—S batteries with core-shell cathodes are overlapping and reveal no severe shrinkage (FIG. 11), in contrast, noticeable shrinkage of the charge and discharge plateaus occurs in Li—S batteries with a conventional cathode (FIG. 12). Such high electrochemical reversibility and stability confirm that the core-shell cathodes stabilize the high sulfur loading in improve battery performance with high sulfur loading.

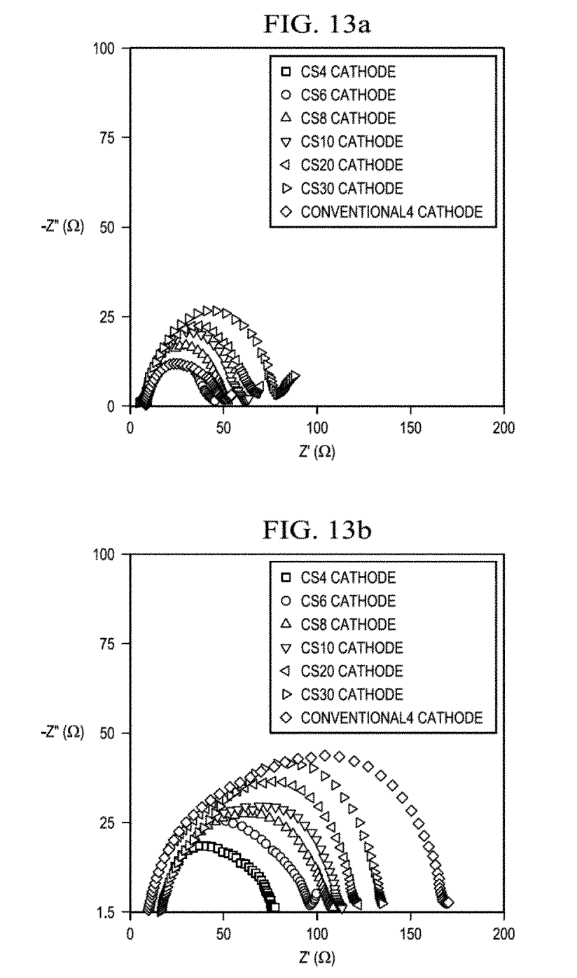

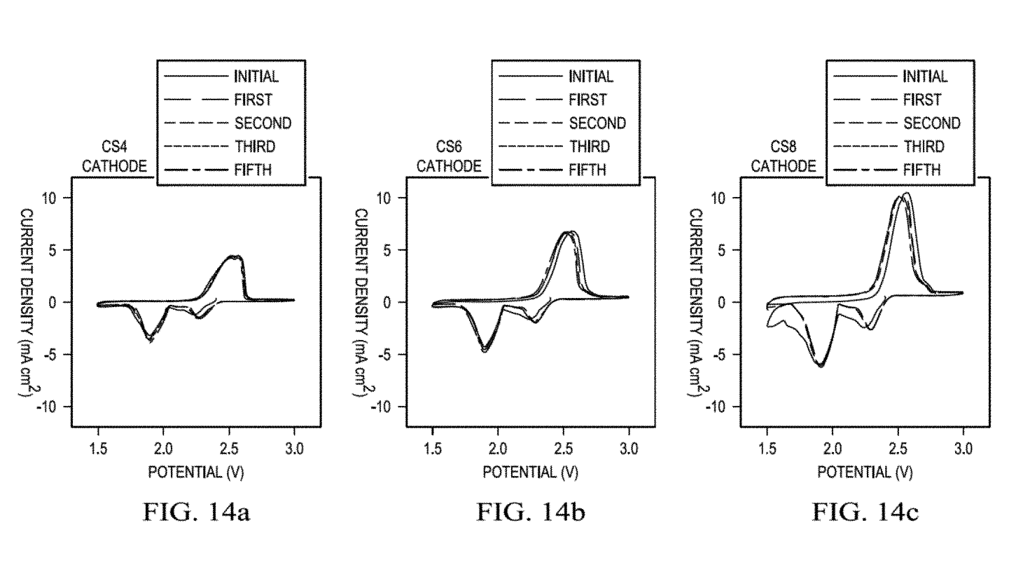

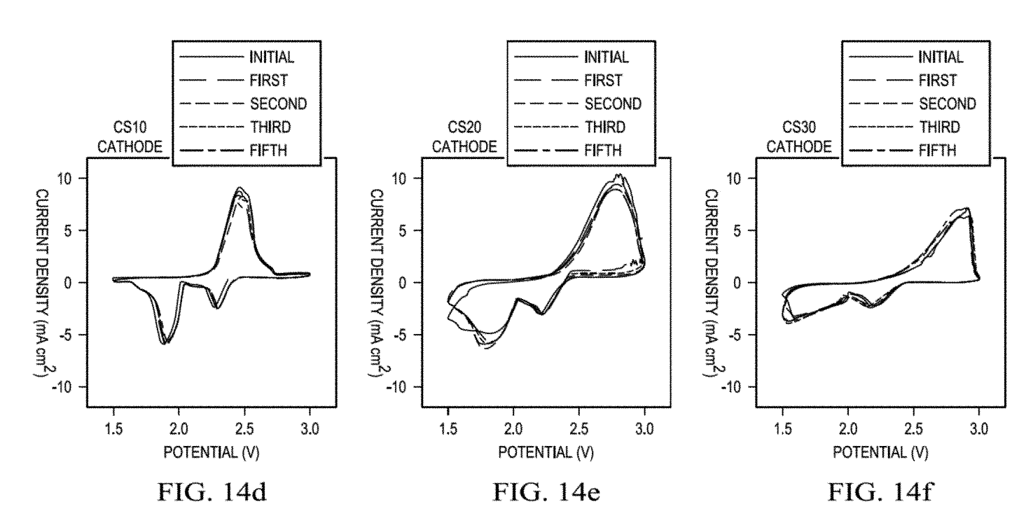

EIS was subsequently used to characterize the transport properties and electrode reactions of the Li—S batteries. FIG. 13 displays the EIS results of the core-shell cathodes before and after 100 cycles. The uncycled core-shell cathodes with increasing sulfur loadings displayed a low charge-transfer resistance of less than 75 ohms. It is evident that the conductive carbon paper shell improves the cathode conductivity so as to enhance the redox reaction kinetics. After cycling, in contrast to the conventional sulfur cathode, which showed a significant increase in cell resistance at only 50 cycles, the core-shell cathodes maintained a low cell resistance for 100 cycles and exhibited a limited increase in cell resistance even as the sulfur loadings increase from 4 to 30 mg/cm². This indicates that high sulfur loading achieved improved electrochemical kinetics because the sulfur-based core remained enclosed within the carbon paper shell. The reversibility of such high redox-reaction capability is reflected in the dynamic electrochemical stability of the core-shell cathodes with increasing sulfur loadings, such as the overlapping discharge and charge curves during repeated cycling (FIG. 11) and the reversible cyclic voltammograms during redox conversions (FIG. 14).

The appearance of complete and overlapping discharge/charge and CV scanning curves provides qualitative support for the improved electrochemical reversibility when a core-shell cathode is used in a Li—S battery, as opposed to a conventional cathode. Further electrochemical analysis on the upper-plateau discharge capacity (QH) and the lower-plateau discharge capacity (QL) is shown in FIG. 10B quantifies respectively, the polysulfide retention and the electrochemical reactivity of the batteries. The QH has a theoretical value of 419 mAh/g, corresponding to the formation of polysulfides and polysulfide diffusion and shuttling. Thus, change in QH as a function of cycle numbers reflects the polysulfide-retention capability of a Li—S battery. QL has a theoretical value of 1256 mAh/g and is mainly attributed to the slow conversion of polysulfides to a mixture of Li₂S₂ and Li₂S and subsequent electrode degradation during cycling. The change in the QL value as a function of cycle number, therefore, reveals the redox-conversion capability of a Li—S battery. The core-shell cathodes exhibited high QH and QL utilization rates (average values of, respectively, 81% and 71%) and stable retention rates (average values of, respectively, 65% and 60%) throughout 100 cycles, demonstrating a better polysulfide-retention capability and redox-conversion ability than conventional a cathode, which suffered from severe polysulfide diffusion and electrode degradation and had low retention rates for QH and QL at, respectively, 21% and 42% after only 50 cycles.

The analytical values of QH and QL are summarized in detail in Table 2. Results for the conventional cathode are after 50 cycles. Results for the core-shell cathodes are after 100 cycles.

TABLE 2
QH and QL Values
Parameters QH utilization r Table S2.
Analytical results of Q_{H} and Q_{L} calculation

| | Q_{H} utiliza- | Q_{L} utiliza- | Q_{H} reten- | Q_{L} reten- |
|---|---|---|---|---|
| | tion rate | tion rate | tion rate | tion rate |
| Parameters | [%] | [%] | [%] | [%] |
| CS4 cathode | 98.73 | 96.02 | 86.05 | 71.38 |
| conventional4 | 88.71 | 53.41 | 20.82 | 42.55 |
| cathode | | | | |

sulfur cores with increasing active-material loadings

| | | | | |
|---|---|---|---|---|
| CS6 cathode | 96.83 | 94.93 | 77.38 | 58.59 |
| CS8 cathode | 93.68 | 76.79 | 59.25 | 58.10 |
| CS10 cathode | 75.02 | 65.11 | 64.99 | 61.89 |
| CS20 cathode | 66.71 | 47.38 | 55.03 | 62.34 |
| CS30 cathode | 52.60 | 43.21 | 49.05 | 42.43 |

### Example 7: Battery Performance Testing of Li—S Batteries with Core-Shell Cathodes

Electrochemical performance of a Li—S battery is directly linked to the total amount of cathode active material. Thus, sulfur loading, sulfur mass per cathode, and sulfur wt % directly affect electrochemical performance. Many existing high sulfur loading cathodes focus on raising only one of these important parameters and they often need slow cycling rates for successful activation and redox conversion, as a result of a high cathode resistance and a corresponding low redox-reaction capability. Thus, the electrochemical performance of Li—S batteries with core-shell cathodes was investigated in detail at increasing sulfur loadings and at various cycling rates.

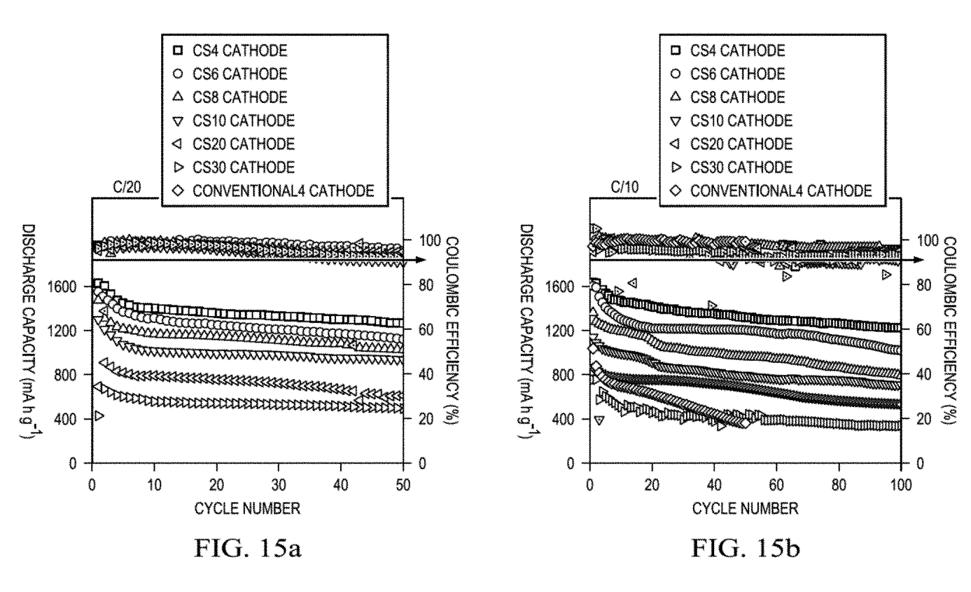

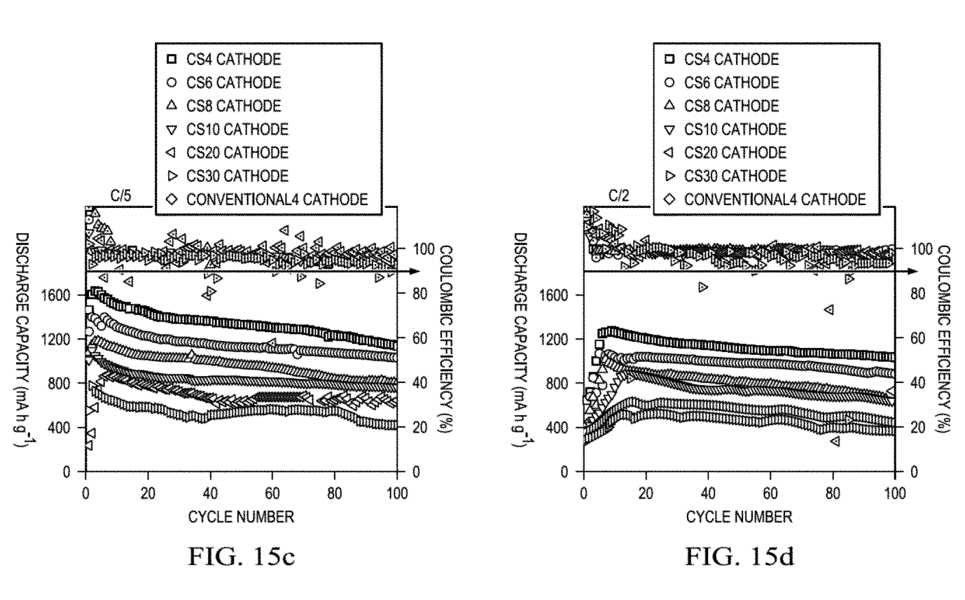

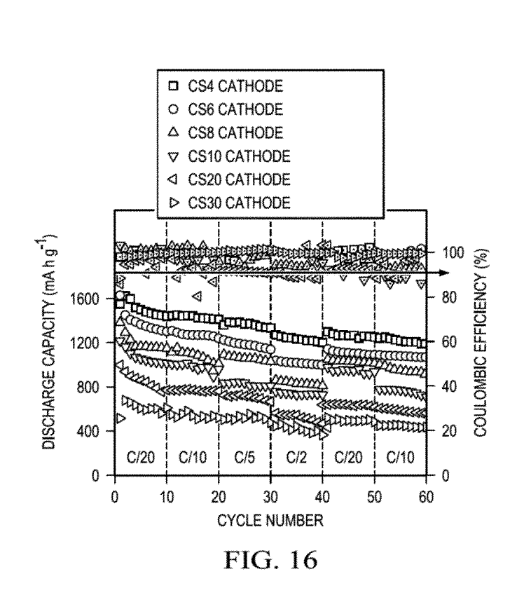

FIG. 15A and FIG. 16 show cyclability of Li—S batteries with core-shell cathodes having increasing sulfur loadings at a C/20 rate in order to show complete reactions and to assess the polysulfide diffusion with sufficient migration time. The batteries exhibited a high capacity of up to 1632 mAh/g, equal to 97% electrochemical utilization of the sulfur core. The superior capacity utilization and retention rates reach, respectively, an average of 74% and 72% with increasing sulfur loadings. Comprehensive performance was also investigated at a C/10 rate. (FIG. 15B and FIG. 16.) The core-shell cathodes attained an excellent electrochemical utilization rate of 97%, corresponding to a high discharge capacity of 1620 mAh/g, in contrast to the conventional sulfur cathode which exhibited only around 60% electrochemical utilization of sulfur. The outstanding electrochemical-reaction capability of the core-shell cathodes allows the sulfur-based core to attain a high sulfur loading and sulfur mass of up to 30 mg/cm² and 30 mg/cathode with a high sulfur content of up to 69 wt % in the cathode. Such high sulfur loading cathodes maintained good cell cyclability for 100 cycles. The reversible capacities of the core-shell cathodes were 1218, 1013, 793, 711, 525, and 340 mAh/g with the sulfur cores containing 4, 6, 8, 10, and 30 mg sulfur, respectively, corresponding to a high average capacity retention of 60%. In contrast, a conventional cathode with a sulfur loading of 4 mg/cm² retained less than 40% of its initial capacity in 50 cycles.

The rate capability of the core-shell cathodes was also investigated. At C/5 and C/2 rates, the core-shell cathodes displayed average capacity retentions of, respectively, 68% and 74% after 100 cycles, indicating good cyclability (FIG. 15C, FIG. 15D, and FIG. 16).

The excellent rate capability was further demonstrated by cycling the Li—S batteries with core-shell cathodes at different rates (FIG. 16). The cathodes exhibited similar cycle stability and reversibility. The stable cell cyclability at slow and fast cycling rates may result from the excellent conductivity and outstanding polysulfide retention capability of the core-shell cathode.

Detailed electrochemical data of the core-shell cathodes with increasing sulfur loadings at various cycling rates are summarized in Table 3. In order to show a fair comparison, the calculations of the capacity retention and fade rates are based on the peak capacities. Results for the conventional cathode are after 50 cycles. Results for the core-shell cathodes are after 100 cycles.

TABLE 3
Electrochemical Data at Various Cycling Rates

| | | | |
|---|---|---|---|
| | Peak | Reversible | Capacity |
| | discharge | discharge | retention rate |
| at C/20 rate | capacity | capacity | [%] (capacity |
| (50 cycles) | [mAh/g] | [mAh/g] | fade rate [%]) |

sulfur cores with increasing active-material loadings

| CS4 cathode | 1632 | 1267 | 77.60 (0.22 |
|---|---|---|---|
| | | | cycle⁻¹) |
| CS6 cathode | 1548 | 1122 | 72.44 (0.25 |
| | | | cycle⁻¹) |
| CS8 cathode | 1472 | 1019 | 69.22 (0.27 |
| | | | cycle⁻¹) |
| CS10 cathode | 1300 | 935 | 71.89 (0.22 |
| | | | cycle⁻¹) |
| CS20 cathode | 910 | 612 | 67.27 (0.18 |
| | | | cycle⁻¹) |
| CS30 cathode | 673 | 496 | 73.62 (0.11 |
| | | | cycle⁻¹) |
| | Peak | Reversible | Capacity |
| | discharge | discharge | retention rate |
| at C/10 rate | capacity | capacity | [%] (capacity |
| (100 cycles) | [mAh/g] | [mAh/g] | fade rate [%]) |
| CS4 cathode | 1620 | 1218 | 75.17 (0.24 |
| | | | cycle⁻¹) |
| conventional4 | 1042 | 362 | 34.77 (0.41 |
| cathode | | | cycle⁻¹) |

sulfur cores with increasing active-material loadings

| CS6 cathode | 1598 | 1013 | 63.34 (0.35 |
|---|---|---|---|
| | | | cycle⁻¹) |
| CS8 cathode | 1357 | 793 | 58.43 (0.34 |
| | | | cycle⁻¹) |
| CS10 cathode | 1132 | 711 | 62.74 (0.25 |
| | | | cycle⁻¹) |
| CS20 cathode | 875 | 525 | 60.00 (0.21 |
| | | | cycle⁻¹) |
| CS30 cathode | 765 | 340 | 44.37 (0.25 |
| | | | cycle⁻¹) |
| | Peak | Reversible | Capacity |
| | discharge | discharge | retention rate |
| at C/5 rate | capacity | capacity | [%] (capacity |
| (100 cycles) | [mAh/g] | [mAh/g] | fade rate [%]) |

sulfur cores with increasing active-material loadings

| CS4 cathode | 1622 | 1134 | 69.89 (0.29 |
|---|---|---|---|
| | | | cycle⁻¹) |
| CS6 cathode | 1399 | 1035 | 73.98 (0.22 |
| | | | cycle⁻¹) |
| CS8 cathode | 1174 | 804 | 68.42 (0.23 |
| | | | cycle⁻¹) |
| CS10 cathode | 1090 | 743 | 68.08 (0.21 |
| | | | cycle⁻¹) |
| CS20 cathode | 867 | 643 | 74.20 (0.14 |
| | | | cycle⁻¹) |
| CS30 cathode | 774 | 423 | 54.56 (0.22 |
| | | | cycle⁻¹) |
| | Peak | Reversible | Capacity |
| | discharge | discharge | retention rate |
| at C/2 rate | capacity | capacity | [%] (capacity |
| (100 cycles) | [mAh/g] | [mAh/g] | fade rate [%]) |

sulfur cores with increasing active-material loadings

| | | | |
|---|---|---|---|
| CS4 cathode | 1274 | 1037 | 81.35 (0.16 |
| | | | cycle⁻¹) |
| CS6 cathode | 1052 | 907 | 86.16 (0.09 |
| | | | cycle⁻¹) |
| CS8 cathode | 1017 | 667 | 65.59 (0.22 |
| | | | cycle⁻¹) |
| CS10 cathode | 885 | 674 | 76.12 (0.16 |
| | | | cycle⁻¹) |
| CS20 cathode | 636 | 464 | 72.91 (0.13 |
| | | | cycle⁻¹) |
| CS30 cathode | 526 | 340 | 64.60 (0.15 |
| | | | cycle⁻¹) |

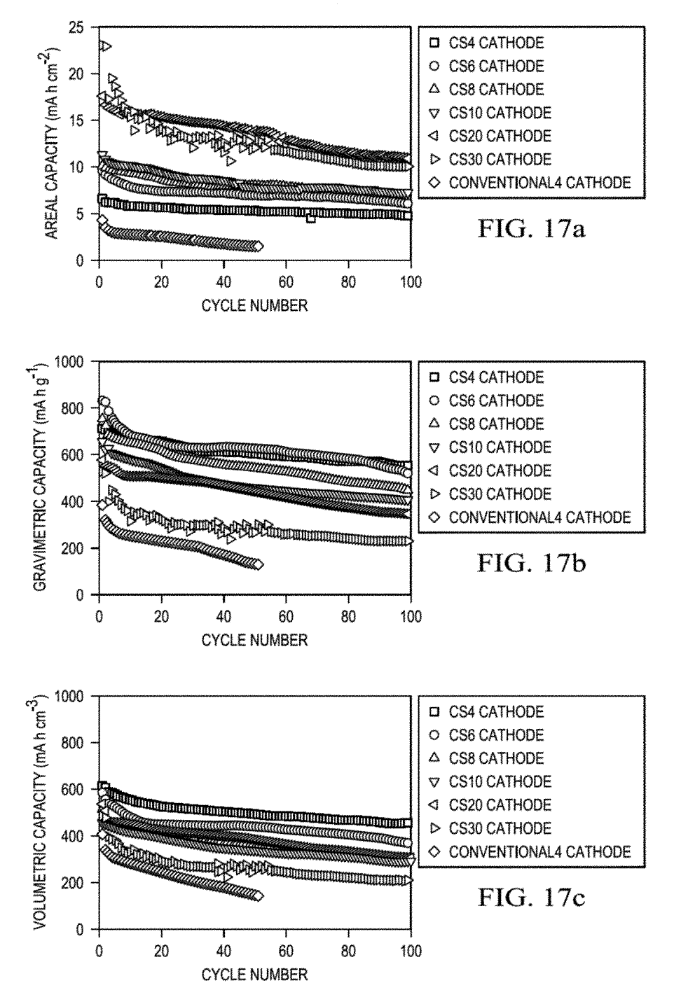

FIG. 17 provides comparative battery performance data for areal capacity (mAh/cm²) (FIG. 17A)), gravimetric capacity (mAh/g) (FIG. 17B), and volumetric capacity (mAh/cm³) (FIG. 17C) of the whole electrode. For the core-shell cathodes, the whole electrode weight and volume includes the sulfur-based core and the carbon paper shell. For the conventional cathode, the whole electrode weight and volume includes sulfur, carbon, binder, and current collector.

The core-shell cathodes delivered high areal capacities of 6 to 23 mAh/cm² for the whole electrode, comparing advantageously with that of commercially available lithium-ion batteries (2-4 mAh/cm²). Moreover, the peak gravimetric and volumetric capacities of the core-shell cathodes (whole electrode) reached up to, respectively, 740 mAh/g and 606 mAh/cm³. In contrast, the conventional cathode provided peak gravimetric and volumetric capacities for the whole electrode of, respectively, 379 mAh/g and 407 mAh/cm³. When core-shell cathodes were equipped with high sulfur loadings, they still exhibited high gravimetric and volumetric capacities due to high redox accessibility and reversibility.

### Example 8: Static Testing of Li—S Batteries with Core-Shell Cathodes

Many Li—S batteries exhibit severe self-discharge during storage, limiting their practical use. Self-discharge occurs because, during periods of rest, the cathode active material that is exposed to the electrolyte continuously reacts with the electrolyte to form polysulfides, which dissolve into the liquid electrolyte and migrate to the anode side of the battery because of the concentration gradient. The sulfur-to-polysulfide conversion and the ensuing polysulfide diffusion are reflected in a decrease in the OCV and the storage capacity.

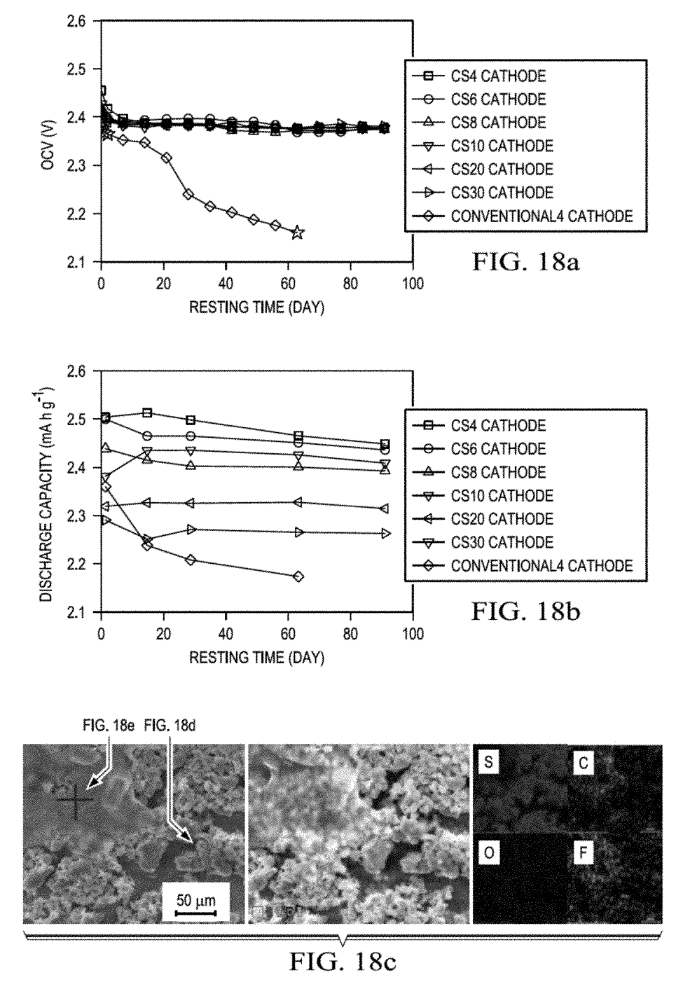

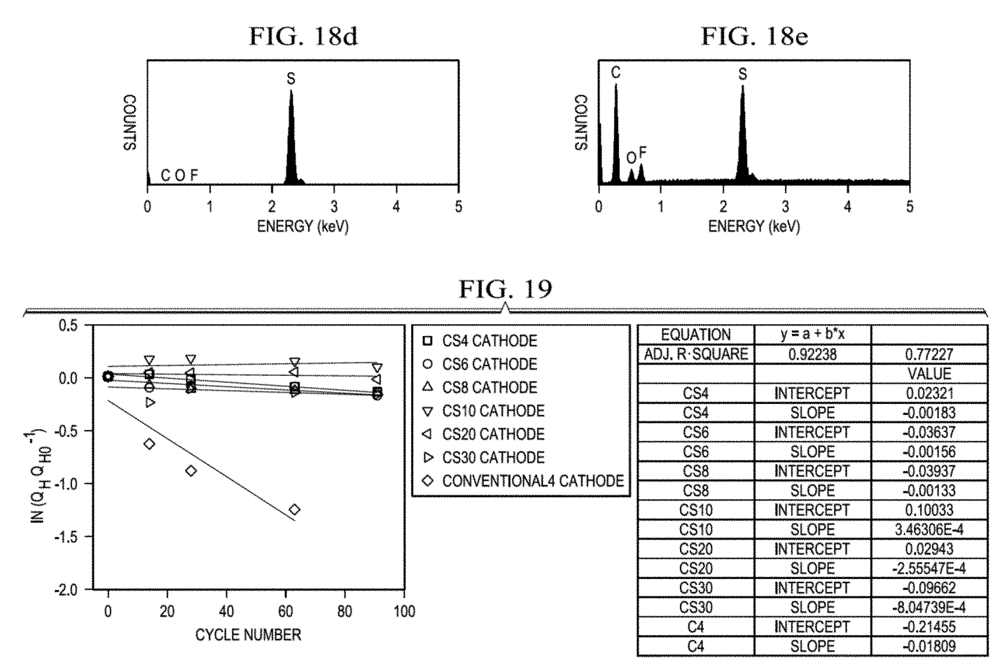

The time-dependent OCVs of Li—S batteries containing core-shell cathodes were rec-orded with respect to their statistic electrochemical characteristics (FIG. 18A). The core-shell cathodes with various sulfur loadings maintained stable OCV values for three months, in contrast to the conventional cathodes, which showed fast fade in the OCV value within one week. The stable OCV indicated low sulfur-to-polysulfide conversions and low active-material loss during rest. As a result, the Li—S batteries employing the core-shell cathodes exhibited a significantly low self-discharge effect, characterized by a high capacity retention rate of above 85%, and low average capacity fade rates of 0.07%/day for a three-month rest period, as shown in FIG. 18B. In contrast, the conventional cathode suffering from OCV fade exhibited a low capacity maintenance of only 29% and a high capacity fade rate of 0.71%/day after resting for two months, which is a result of typical self-discharge behavior.

A mathematical model was used to quantify the self-discharge behavior of a Li—S battery as a constant an applied to a Li—S battery with a core-shell cathode. (FIG. 19.) The self-discharge constant (Ks) is determined by comparing the QH and its initial value (QH₀) as a function of the resting time (TR: day) as: ln(QH/QH0)=−Ks×TR. The core-shell cathodes with increasing sulfur loadings of 4, 6, 8, 10, 20, and 30 mg/cm² had low KS values of, respectively, 0.0018, 0.0016, 0.0013, 0.0003, 0.0003, and 0.0008/day, and an average Ks value of 0.0012/day. The low KS value provide quantitative evidence that the core-shell cathode enclosed the sulfur=based core and keeps the cathode active material from dissolving into the electrolyte during long-term storage. As a reference, the conventional cathode showed a high Ks value of 0.0181/day, indicating a typical severe self-discharge.

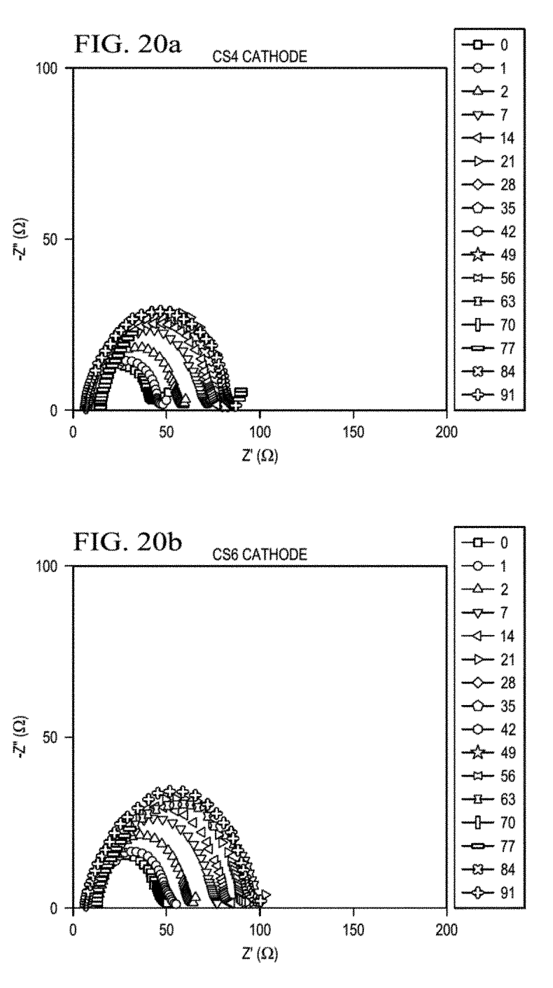

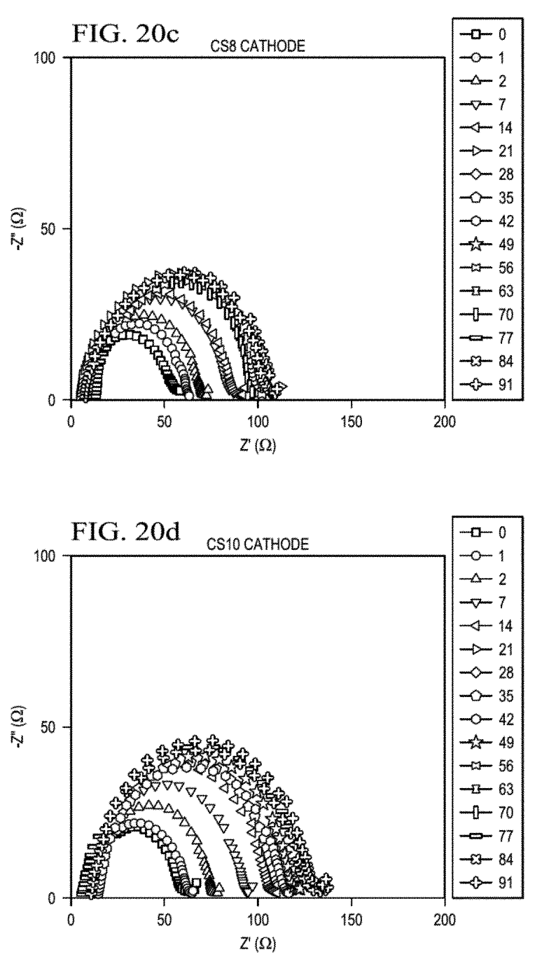

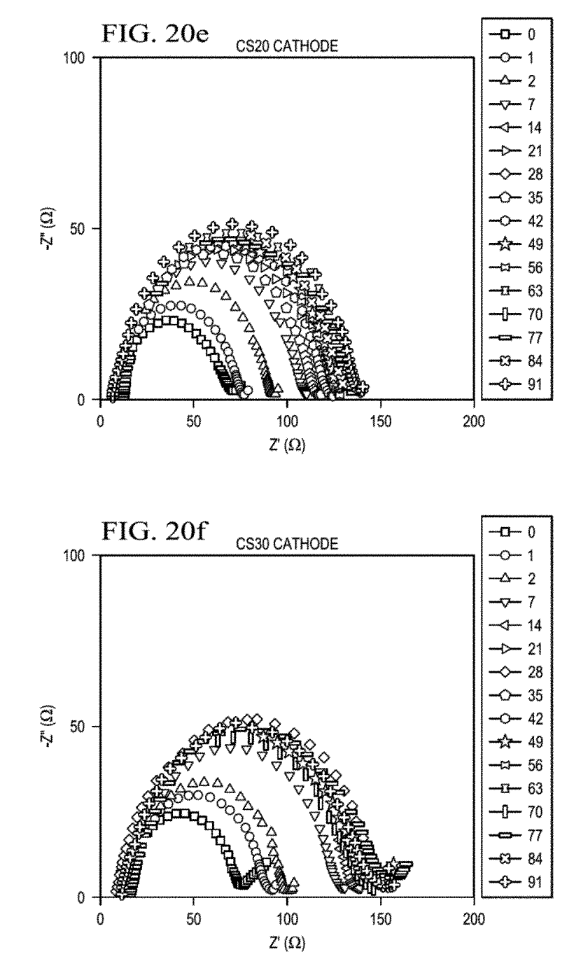

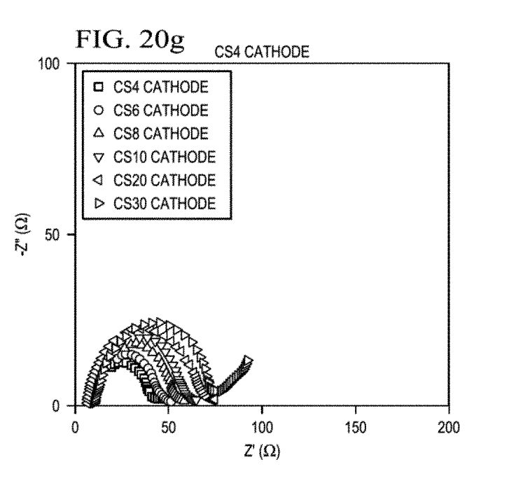

Time-dependent EIS was also performed in parallel to analyze the electrode reactions during resting. (FIG. 20.) EIS showed a slight increase in cell impedance during the initial 14-day rest period and then showed stable impedance during the remainder of the three-month rest period. Low impedance suggests a stable electrochemical and chemical environment as a result of the limited dissolution and diffusion of the cathode active material. In addition, the steady impedance after two weeks indicates stable static electrode reactions, a result of the limited sulfur-to-polysulfide conversion and suppressed polysulfide diffusion, which reduced or eliminates Li₂S/Li₂S₂ re-deposition during resting.

Further evidence of the limited dissolution and diffusion of the cathode active material during resting is provided by SEM/EDX analysis. FIG. 18C presents the breaking-surface SEM/EDX results for a core-shell cathode after a three month rest period. In addition, the carbon paper shell was peeled off so that the sulfur-based core could be investigated. The core exhibited almost unchanged morphology, clustering of sulfur particles, and strong elemental sulfur signals. (FIG. 18D.) The carbon paper shell that was intentionally left on the sulfur-based core reflected strong elemental carbon signals and still tightly covered the sulfur clusters. (FIG. 18E). These features illustrate limited cathode active material degradation during long-term storage.

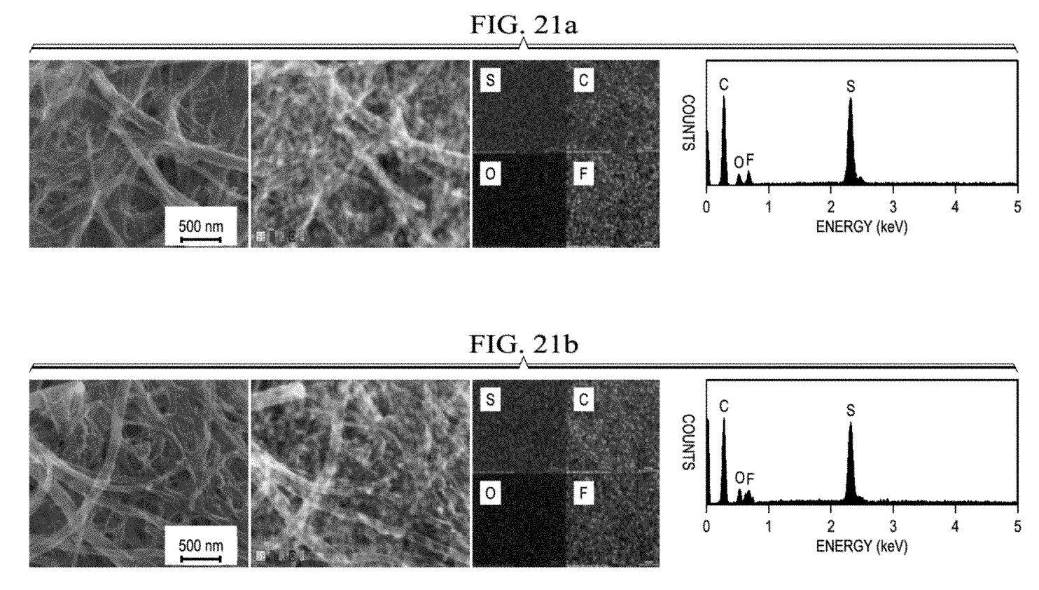

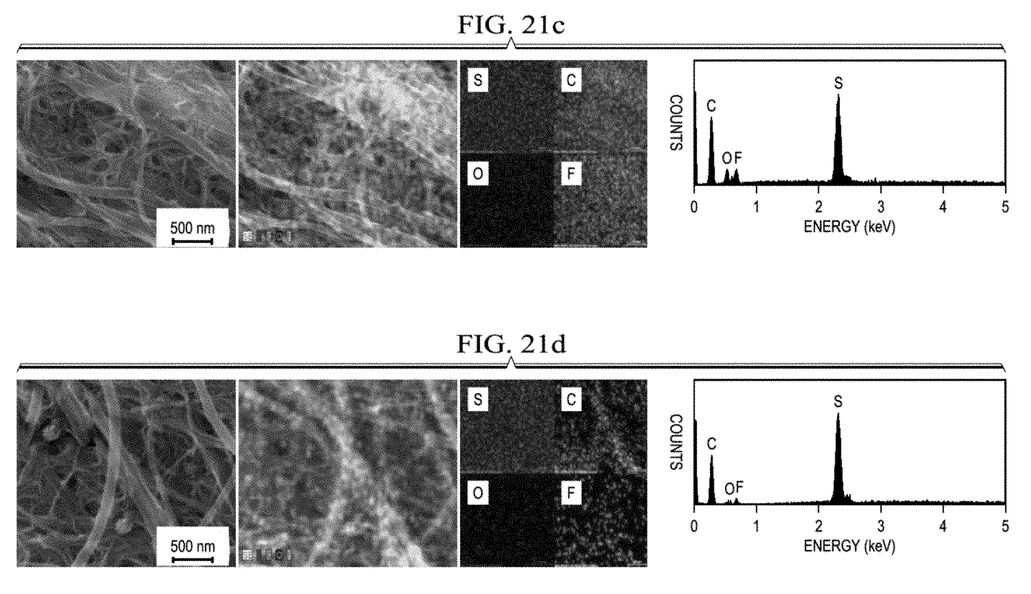

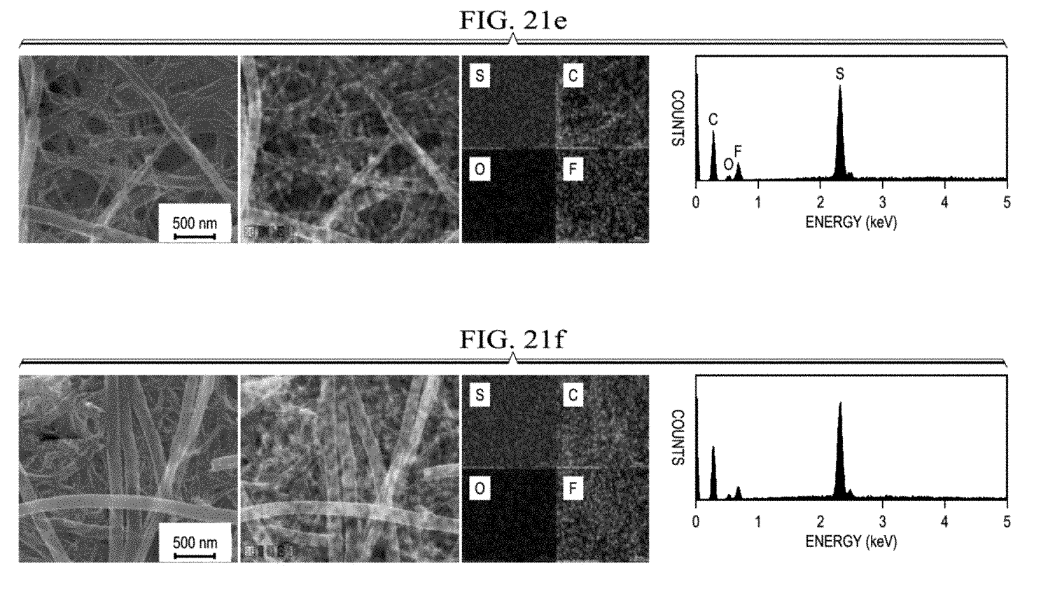

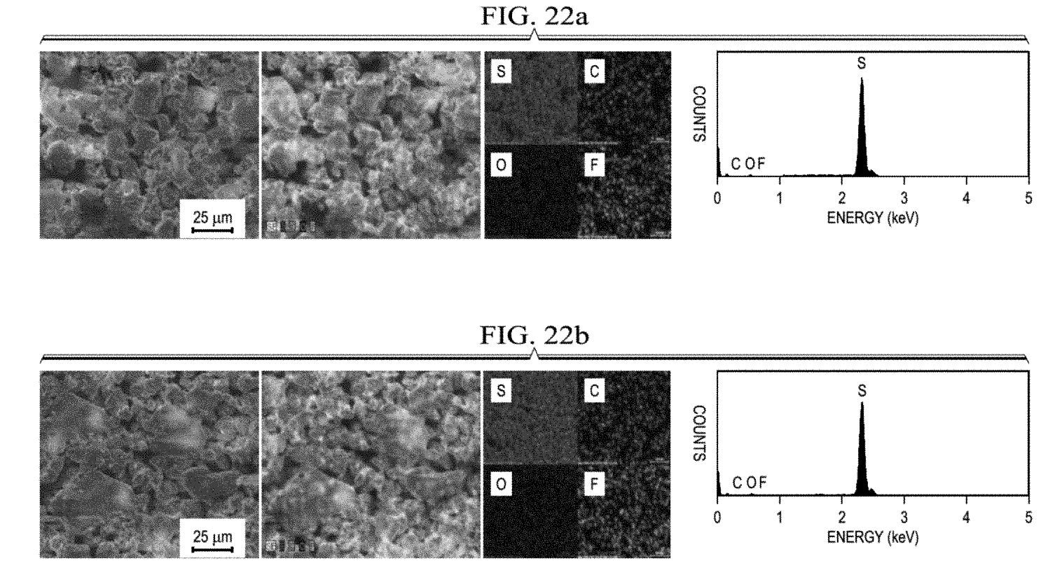

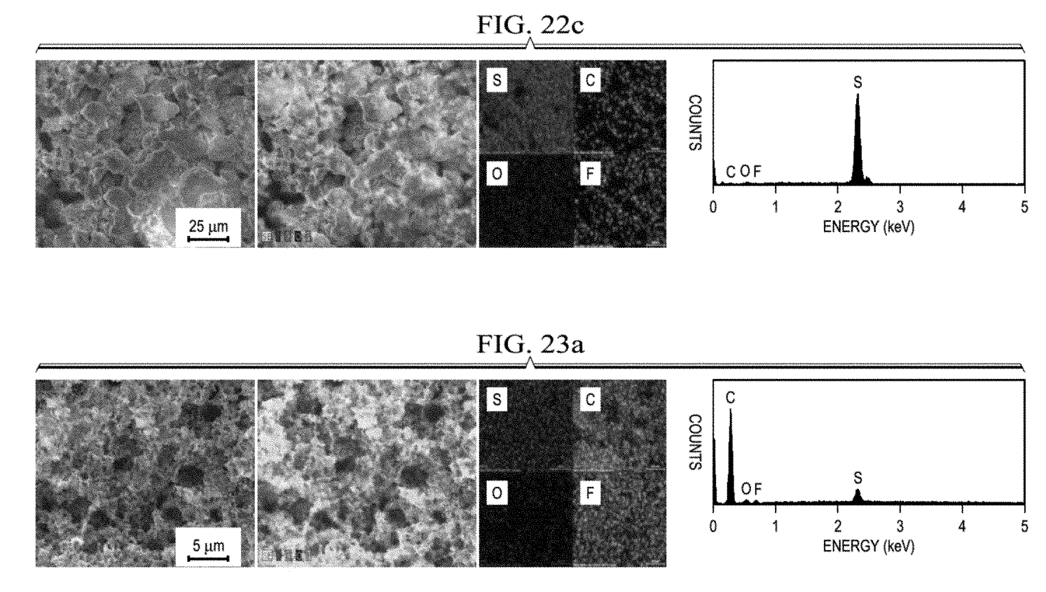

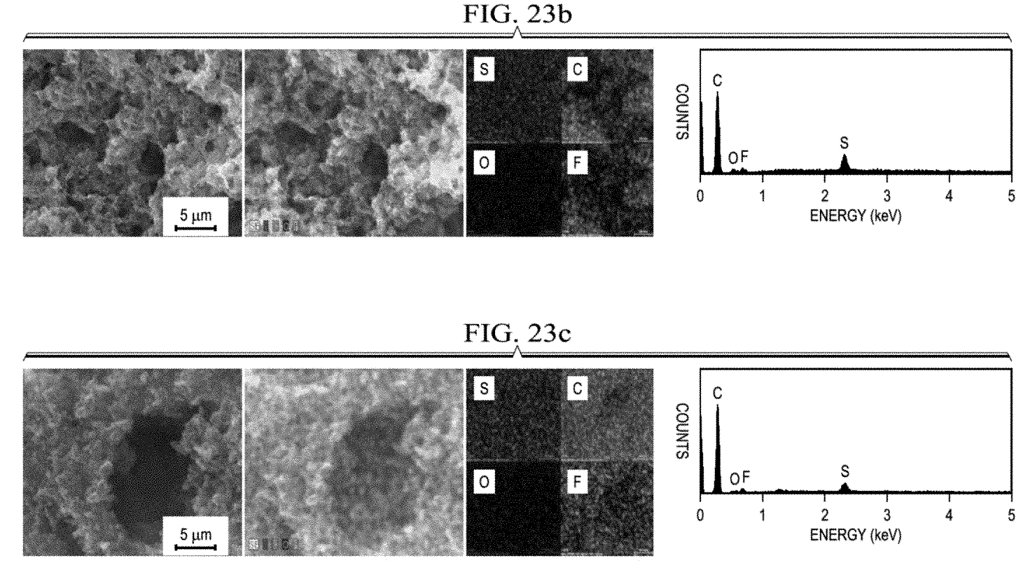

A detailed comparative analysis of the microstructure inspection between the core-shell cathodes and the conventional cathodes is provided in FIG. 21-FIG. 23. First, in FIG. 21, the surface SEM and EDX inspections of the core-shell cathodes show, respectively, unchanged morphology and high elemental sulfur intensity after resting for three months, demonstrating that there is no substantial cathode active-material loss from the core-shell cathodes during rest. Second, in FIG. 22, the sulfur-based cores that were enclosed by the carbon paper shell still consisted of sulfur particles and clusters after resting for one, two, and three months. The cathode active material in granules and clusters suggests limited sulfur-to-polysulfide conversion. These two features demonstrate the static stability of the core-shell cathode. Such cathode integrity compares advantageously with that of the conventional cathode, which is characterized by a loss of active materials. (FIG. 23.) It is evident that the dissolution and diffusion of cathode active material left many more empty pores to the conventional cathode and, therefore lowered its elemental sulfur signals.

During resting, the carbon paper shells enclosed and contained the sulfur-based cores, even at high sulfur loadings. As a result, the core-shell cathodes protected their active material from (i) sulfur-to-polysulfide conversion and (ii) severe polysulfide diffusion during long-term storage. Therefore, the core-shell cathode design eliminated the irreversible capacity fade problem of pure sulfur electrodes during cell resting.

### Example 9: Polysulfide Trap Studies of Li—S Batteries with Core-Shell Cathodes

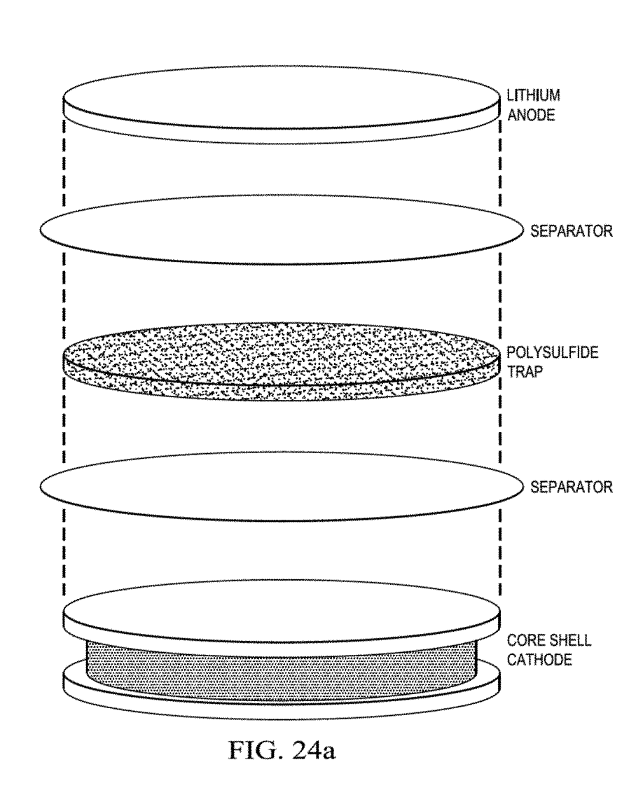

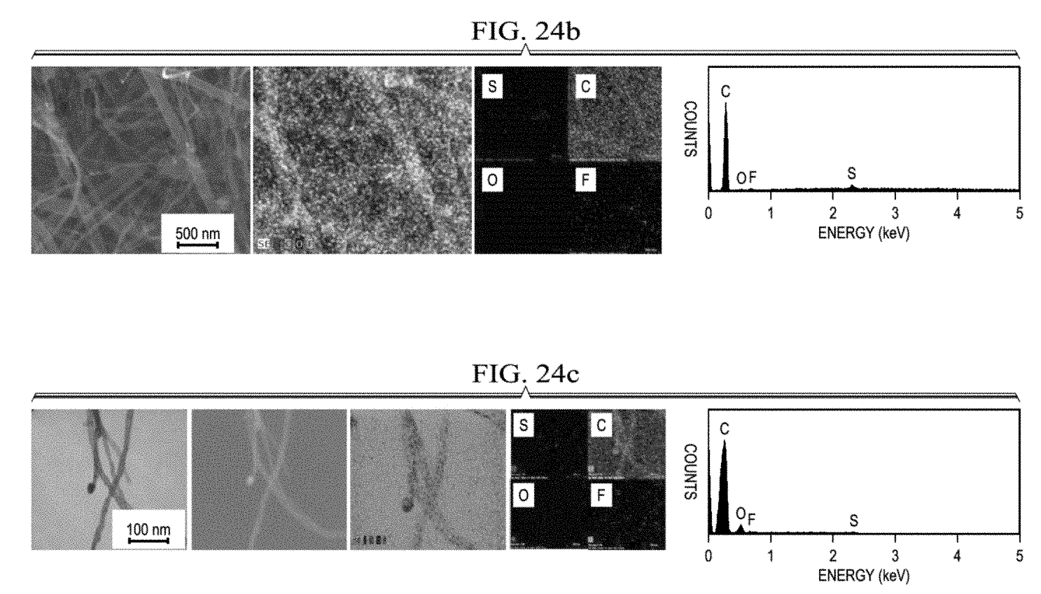

A Li—S battery with a layer of carbon paper in between two layers of the polymeric separator was assembled. (FIG. 24A.) By investigating the polysulfide trap after battery cycling and resting, solid evidence confirmed the presence or absence of substantial polysulfide diffusion. FIG. 24B and FIG. 24C show both the SEM/EDX and STEM/EDX data, respectively, of the fresh polysulfide trap as a reference for the following analyses. The fresh polysulfide traps were confirmed to contain a pure CNT/CNF matrix.

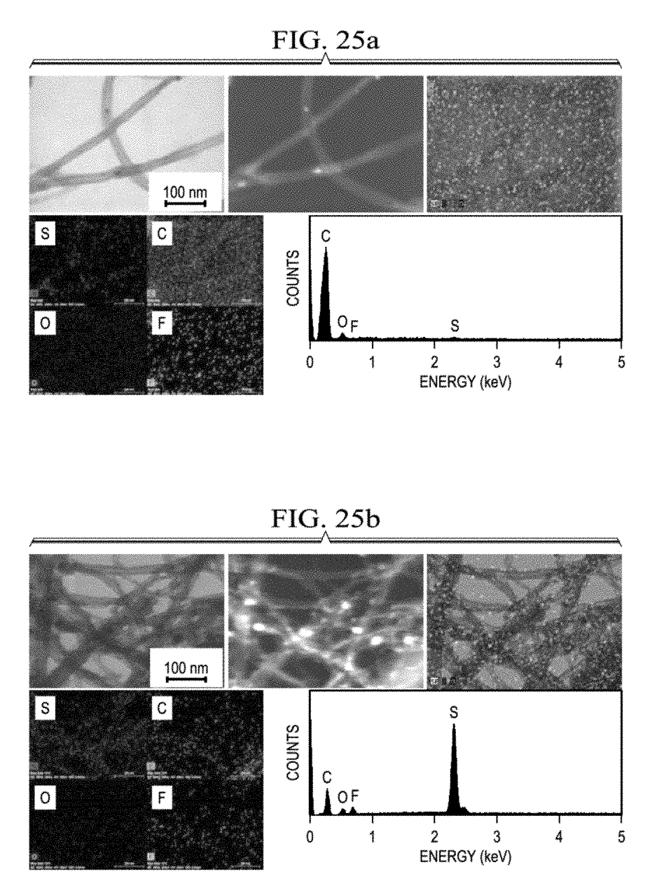

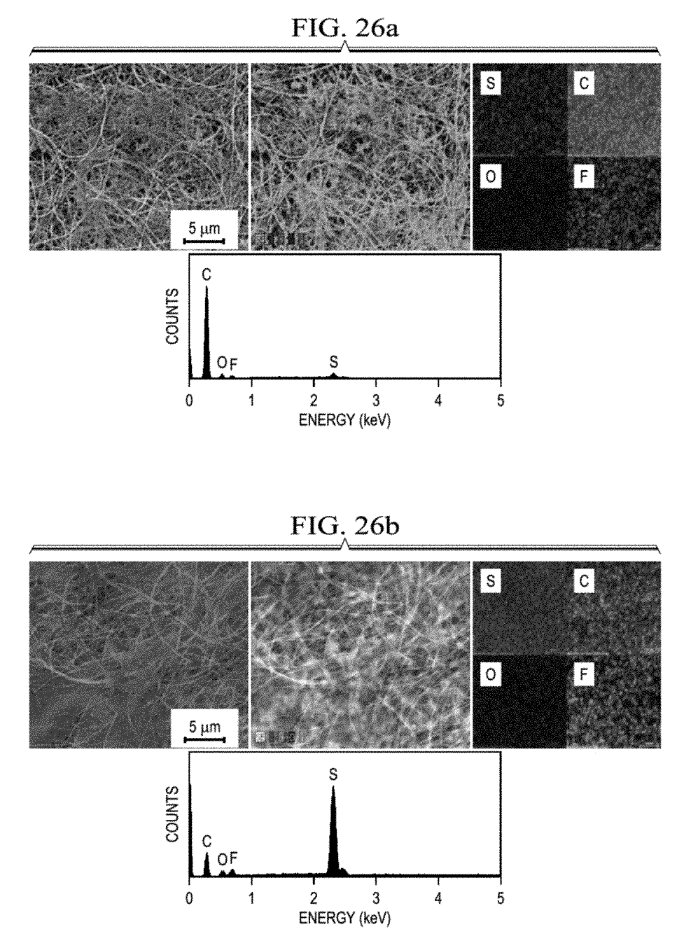

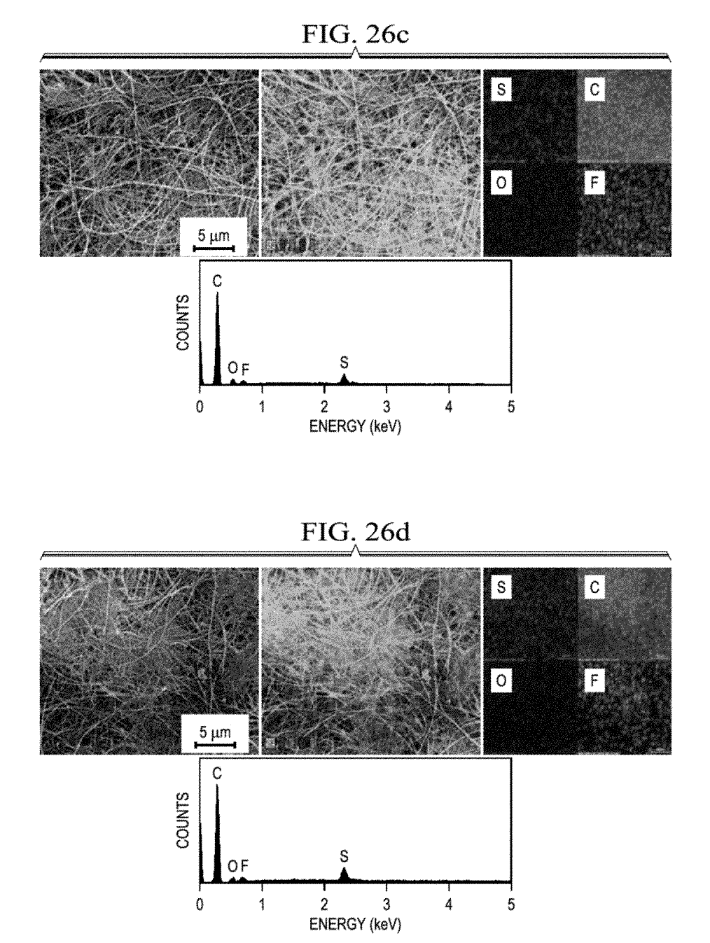

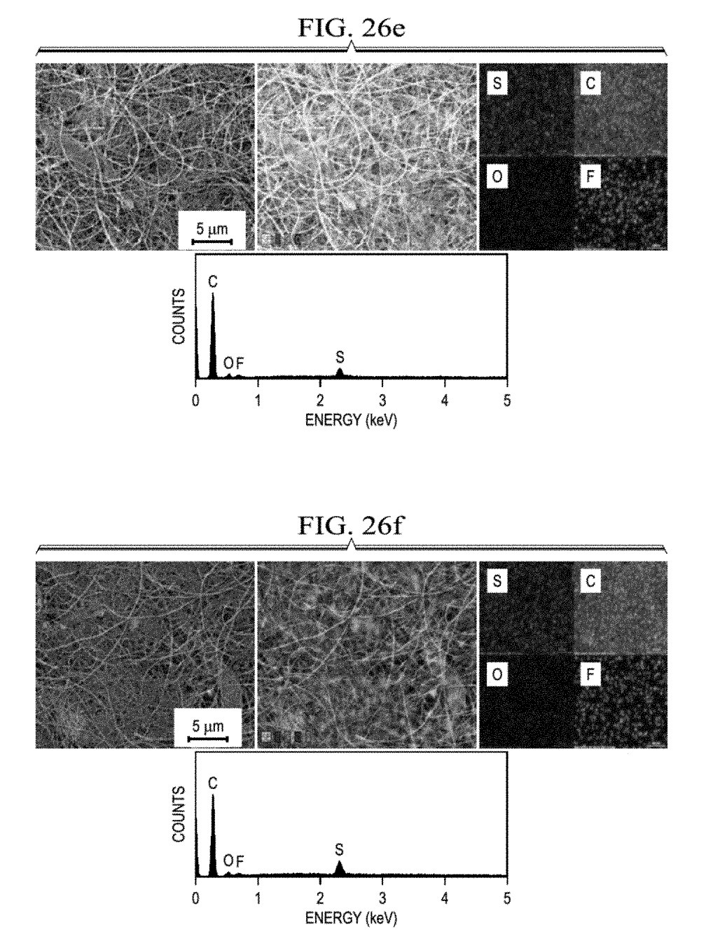

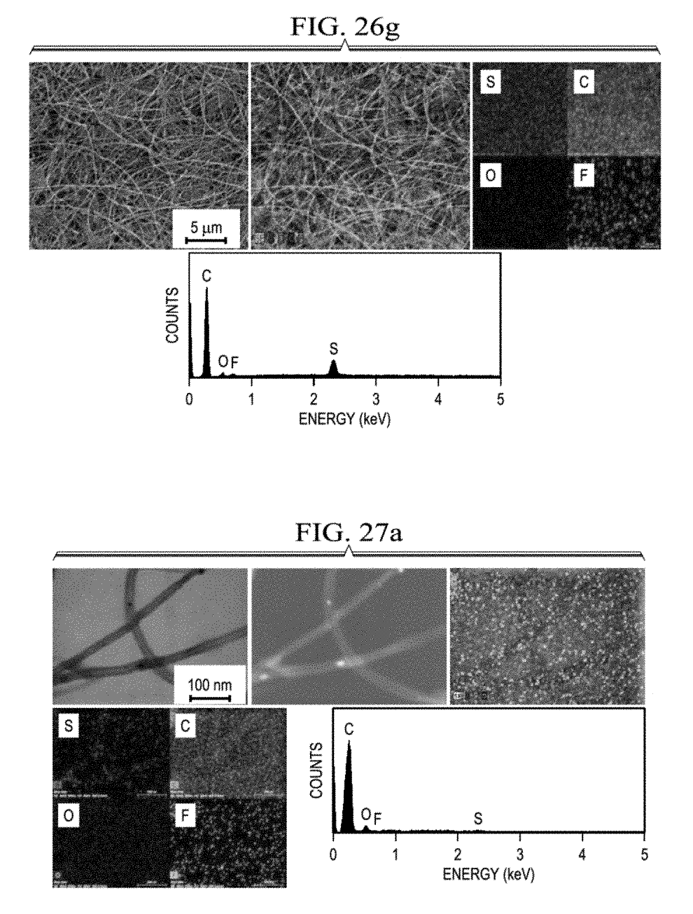

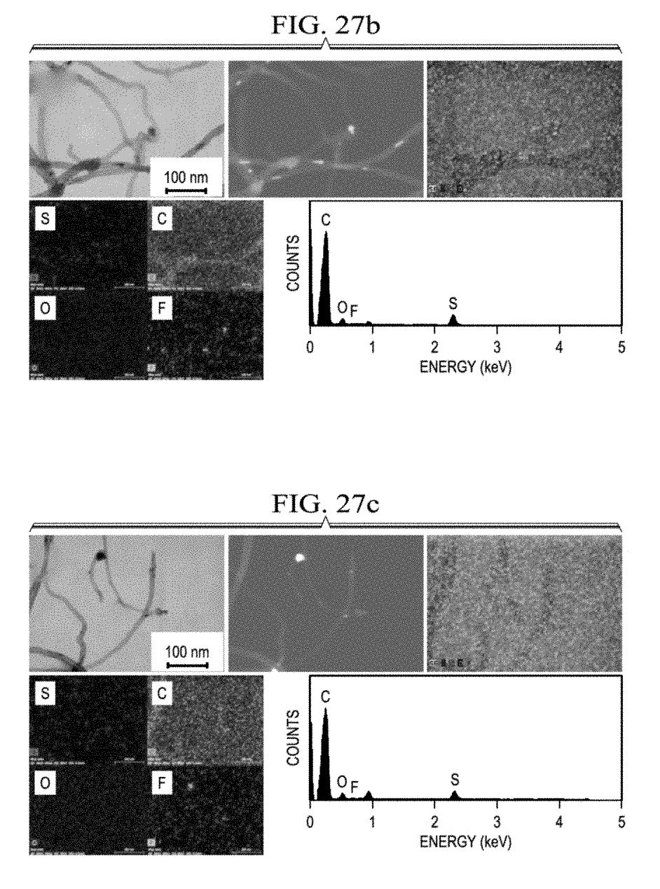

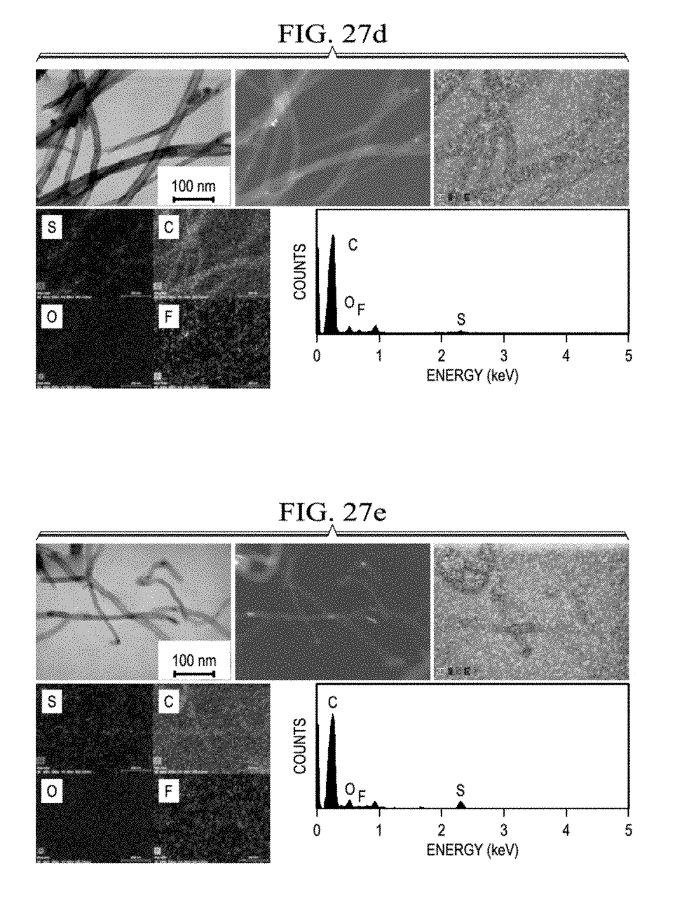

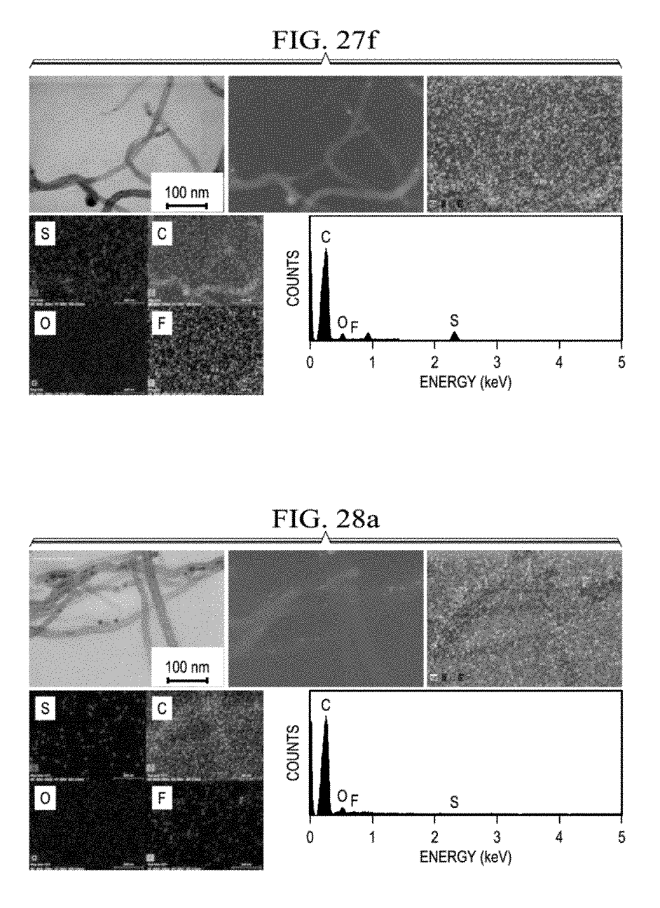

FIG. 25 shows STEM/EDX data from polysulfide traps retrieved from cycled batteries containing either a core-shell cathode (FIG. 25A), or a conventional sulfur cathode (FIG. 25B). FIG. 26 provides SEM/EDX data for a variety of sulfur loadings and FIG. 27 provides SEM/EDX data for a variety of sulfur loadings. After cycling, in comparison to the fresh polysulfide trap, the cycled polysulfide traps in the batteries with core-shell cathodes exhibited similar morphology in the SEM and STEM images and reflected only the strong intensity of elemental carbon signals in both elemental mapping results and EDX spectra (FIG. 25A, FIG. 26A, FIG. 27A.) The absence of the trapped cathode active material and the weak elemental sulfur signals from the cycled polysulfide trap suggest suppressed polysulfide diffusion. The dissolved polysulfides were enclosed by the carbon paper shell and faced great difficulty in diffusing out from the cathode. This was true for the entire range of sulfur loadings tested. (FIG. 26C-FIG. 26G and FIG. 27C-FIG. 27F.)

The STEM images of FIG. 25A show both the bright field (BF-STEM, left) and dark field (DF-STEM, right) detections for microstructure observation and light/heavy element analysis. The corresponding DF detection provides additional evidence demonstrating a low number of sulfur-containing species (the bright domains) on the cycled polysulfide trap.

In contrast, for the conventional cathode (FIG. 25B, FIG. 26B, and FIG. 27B), the there was visible cathode active material buildup on the polysulfide trap, as seen by both SEM and BF-STE. There were also deposited sulfur-containing species as shown by the bright domains in DF-STEM. Corresponding elemental analysis revealed strong sulfur signals.

This polysulfide trap data further demonstrates that the carbon paper shell was able to enclose the sulfur-based core and reduce or eliminate polysulfide diffusion during Li—S battery cycling, in contrast to a similarly loaded conventional cathode.

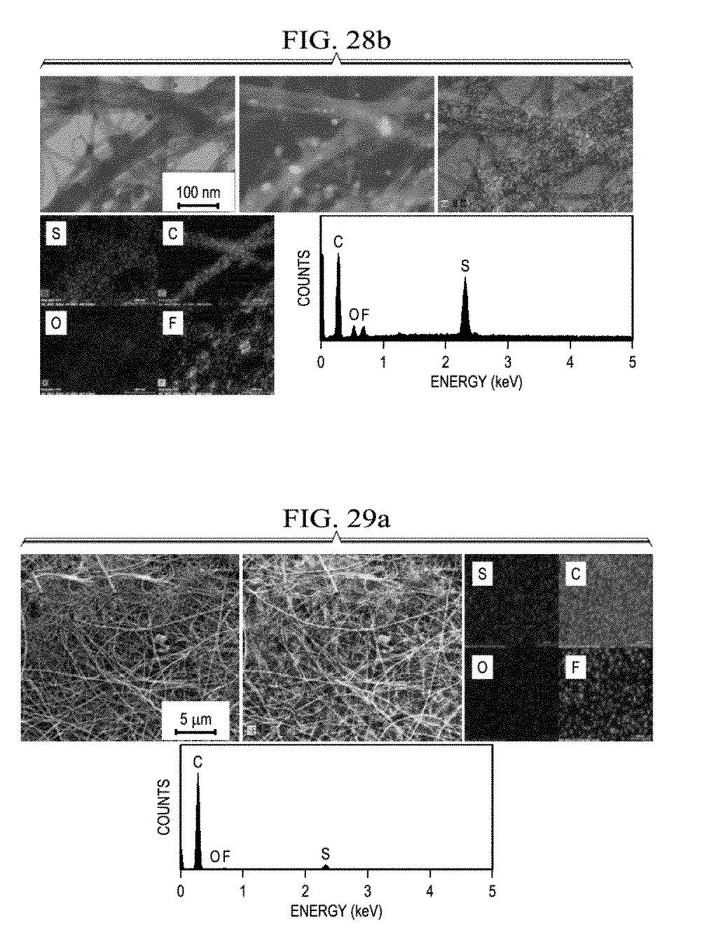

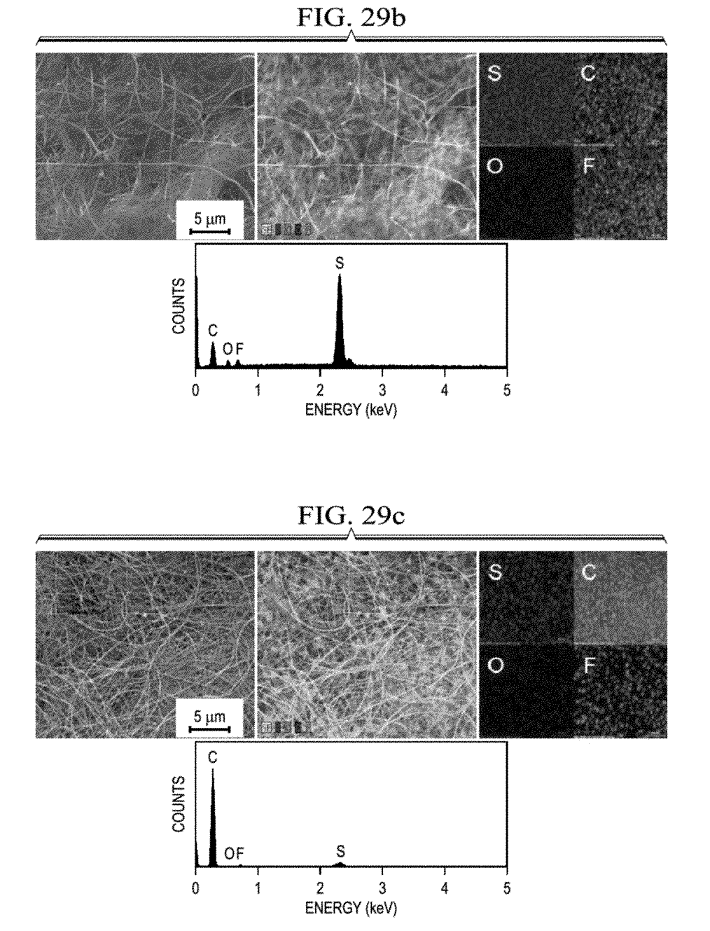

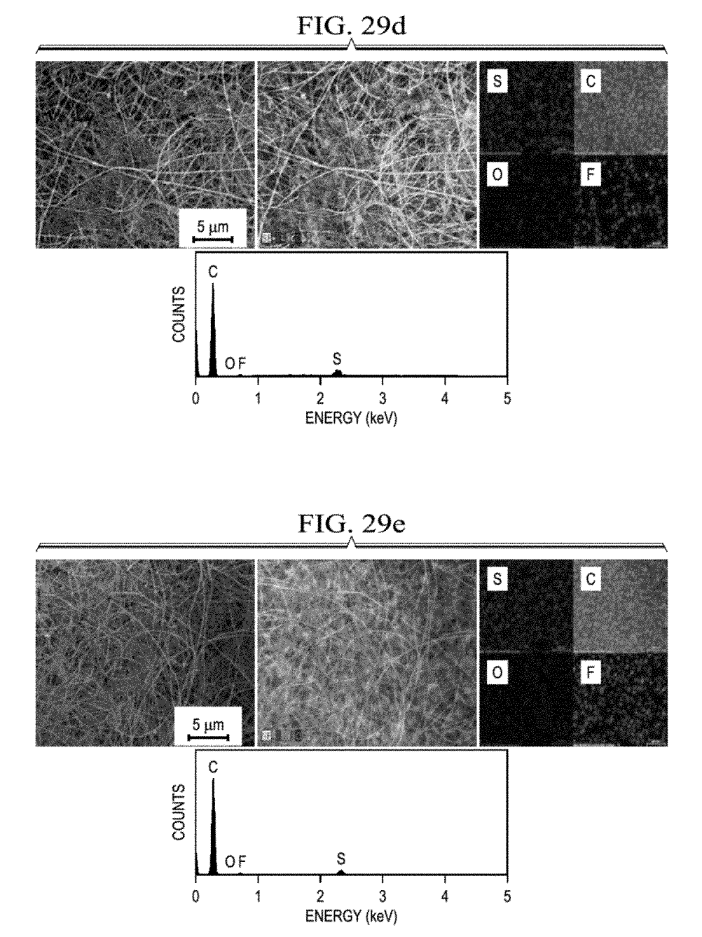

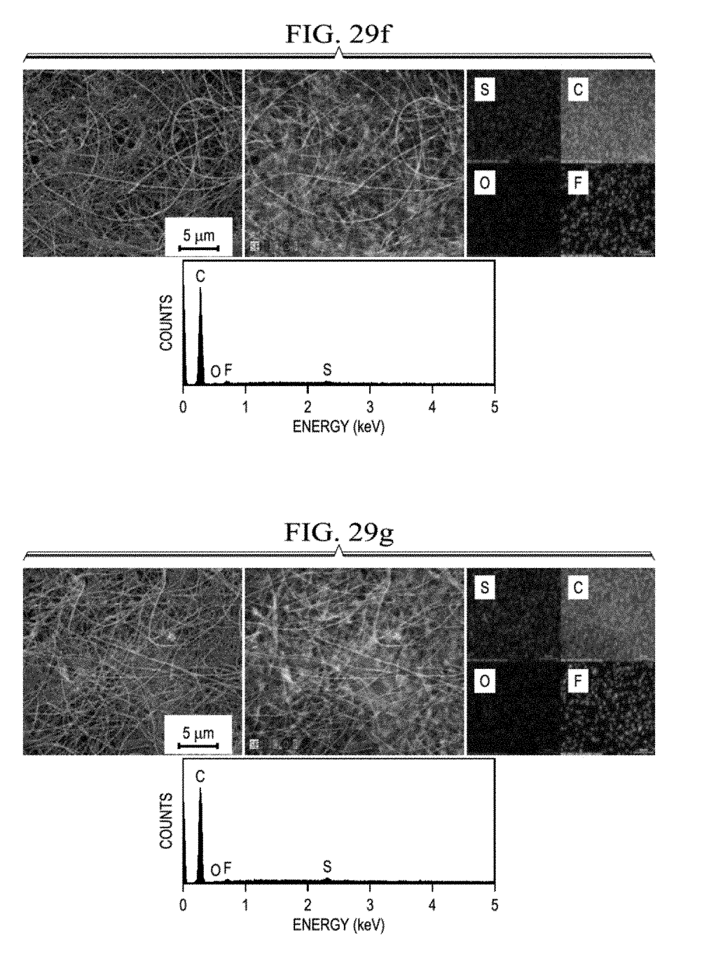

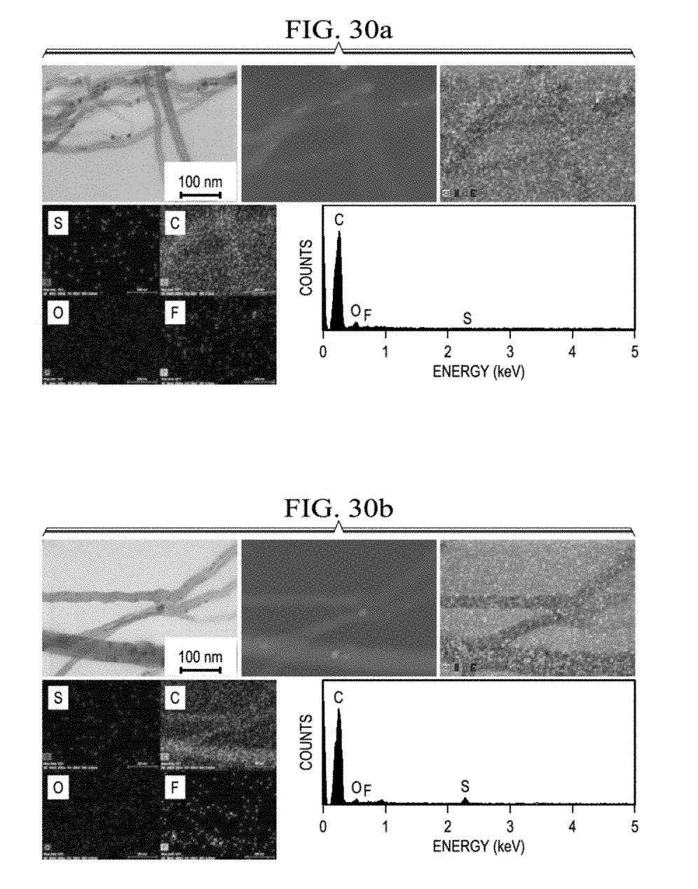

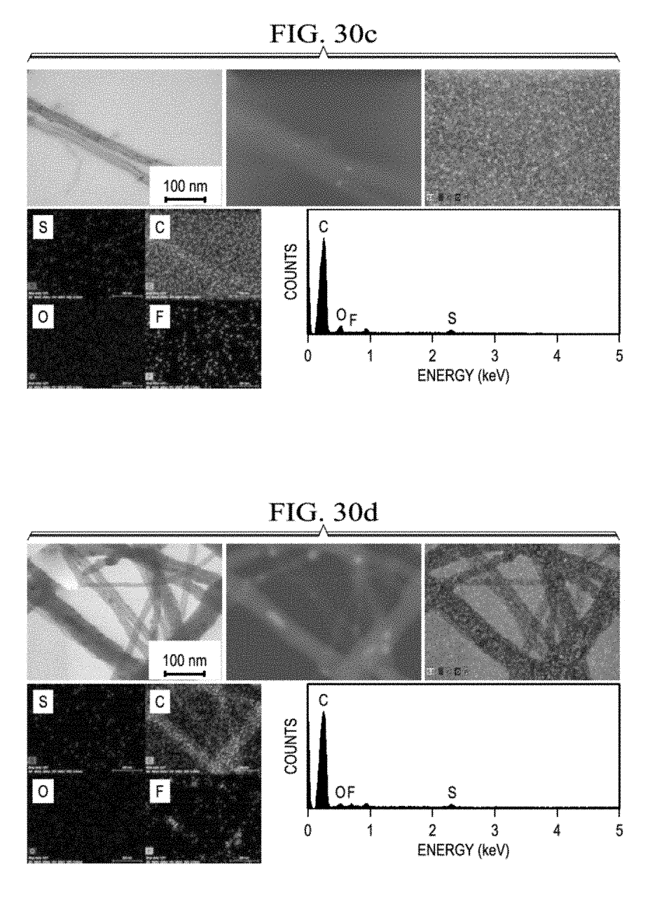

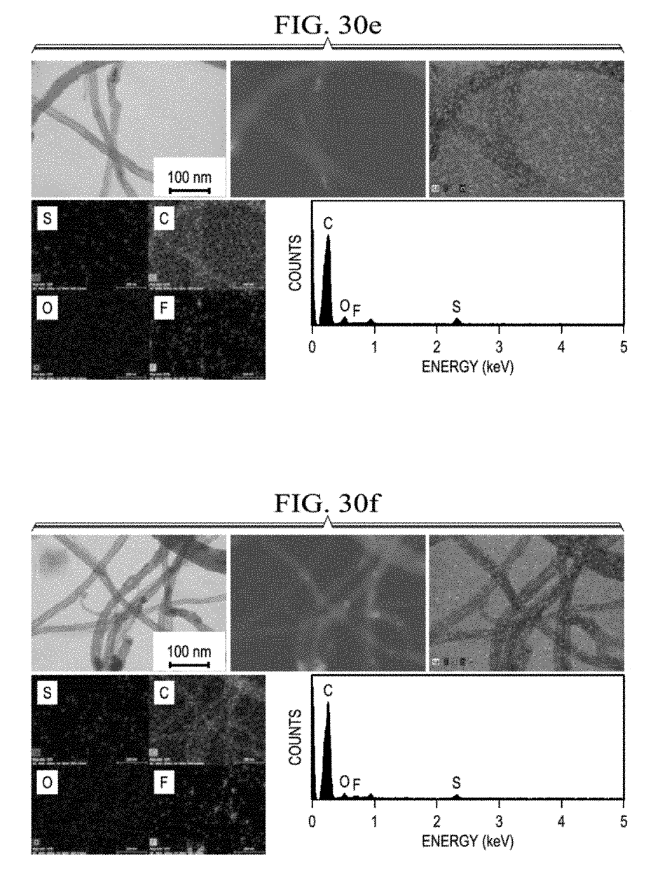

Static polysulfide diffusion was also investigated in Li—S batteries containing a core-shell cathode (FIG. 28A), or a conventional cathode (FIG. 28B). FIG. 29 provides SEM/EDX data for a variety of sulfur loadings and FIG. 30 provides SEM/EDX data for a variety of sulfur loadings. After a three-month rest period, the BF- and DF-STEM analyses for the polysulfide traps in the Li—S batteries with core-shell cathodes showed nearly no sulfur-containing species on the polysulfide traps. The polysulfide trap retained a smooth exterior with no surface coverings. The corresponding DF detection and elemental analysis showed no obvious elemental sulfur signals. As the sulfur loadings increased, the outstanding polysulfide-retention capability of the core-shell cathodes effectively enclosed the sulfur-based cores, even at high sulfur loadings, and suppressed self-discharge. Thus, both the morphological observations and elemental inspections of the polysulfide traps revealed almost no surface coverings caused by diffusing cathode active material. Elemental analysis also showed very limited signals from the sulfur-containing species (FIG. 29A-FIG. 29G and FIG. 30A-FIG. 30F). These results affirm the outstanding polysulfide retention of the core-shell cathode and evidence the high stability of the sulfur cores during rest.

In contrast, the polysulfide trap inserted in the control cell with a conventional cathode provided insight into the static cathode active material loss that resulted from polysulfide dissolution and diffusion. The diffusing sulfur-containing species were blocked by the polysulfide trap so as to create mud-shaped coverings and revealed obvious elemental sulfur signals on the polysulfide trap, as shown in FIG. 28B.

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount.

1. A core-shell cathode comprising:
an electrically conductive, porous shell; and
a sulfur-based core enclosed within the shell,
wherein the electrically conductive, porous substantially encloses the sulfur-based core on a macro-scale and substantially blocks passage of polysulfides from the cathode.

2. The cathode of claim 1, wherein the electrically conductive, porous shell comprises a first layer, an O-ring located on the first layer to form a volume that contains the sulfur-based core, and a second layer located on the O-ring to enclose the sulfur-based core.

3. The cathode of claim 1, wherein the electrically conductive, porous shell comprises an electrically conductive, porous carbon material.

4. The cathode of claim 3, wherein the carbon material comprises carbon nanofibers and carbon nanotubes, including single-walled carbon nanotubes, double-walled carbon nanotubes, multi-walled carbon nanotubes, or any combination thereof.

5. The cathode of claim 3, wherein the porous carbon material comprises carbon particles, graphene, or any combination thereof.

6. The cathode of claim 1, wherein the electrically conductive, porous shell comprises a conductive polymer.

7. The cathode of claim 1, wherein the electrically conductive, porous shell comprises a metal foam.

8. The cathode of claim 1, wherein the sulfur-based core comprises elemental sulfur in the form of particles.

9. The cathode of claim 1, wherein the sulfur-based core comprises a lithium sulfide or polysulfide having the general formula Li₂Sₙ, 1≤n≤8.

10. The cathode of claim 1, wherein the sulfur-based core comprises a catholyte.

11. The cathode of claim 1, wherein the cathode is substantially planar and has a sulfur loading of at least 4 mg/cm².

12. The cathode of claim 1, wherein the cathode has a sulfur loading of at least 40 wt %, based on total weight of the core and shell.

13. The cathode of claim 1, wherein the cathode has a sulfur loading of at least 4 mg/cathode.

14. The cathode of claim 1, wherein the cathode has an areal capacity of at least 5 mAh/cm².

15. The cathode of claim 1, wherein the cathode has a volumetric capacity of at least 500 mAh/cm³.

16. The cathode of claim 1, wherein the cathode has an electrode capacity of at least 600 mAh/g.

17. The cathode of claim 1, where the cathode has a specific capacity of at least 1600 mAh/g.

18. A lithium-sulfur (Li—S) battery comprising:
an anode;
an electrolyte; and
a core-shell cathode comprising:
an electrically conductive, porous shell; and
a sulfur-based core enclosed within the shell,
wherein the electrically conductive, porous substantially encloses the sulfur-based core on a macro-scale and substantially blocks passage of polysulfides from the cathode.

19. The Li—S battery of claim 18, wherein cathode has a sulfur utilization of at least 90%, when cycled at any C-rate between C/20 and C/2.

20. The Li—S battery of claim 18, wherein the cathode has a peak discharge capacity of at least 700 mAh/g at C/5 rate.

21. The Li—S battery of claim 18, wherein the battery has a capacity retention of at least 75% over a three-month rest period.

22. The Li—S battery of claim 18, wherein the battery has a capacity fade of less than 0.1%, per day over a three-month rest period.
